(19) United States
(12) Patent Application Publication
(10) Pub. No.: US 2005/0149860 A1
(43) Pub. Date: Jul. 7, 2005

(54) Electronic device manufacture support apparatus, manufacture client terminal device, and recording medium

(75) Inventor: Yoshiyuki Murata, Ome-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 11/075,337

(22) Filed: Mar. 8, 2005

Related U.S. Application Data
(63) Continuation of application No. PCT/JP03/16959, filed on Dec. 26, 2003.

(30) Foreign Application Priority Data
Dec. 27, 2002 (JP) 2002-382374

(51) Int. Cl. G06F 17/21

(52) U.S. Cl. 715/513

(57) ABSTRACT

When, in response to manipulation of any one of select keys in a keyboard of an electronic device image to be displayed on a network by a communication device, electronic dictionary name data sequentially changed over and displayed on a surface of the select key is received, predetermined dictionary data corresponding to the received electronic dictionary name data is written into an electronic dictionary storage unit provided in an actual electronic dictionary corresponding to the electronic device image. The corresponding electronic dictionary name data is marked on a surface of the select key in the actual electronic dictionary corresponding to the received electronic dictionary name data. Thus, a support apparatus can manufacture an electronic device easily and automatically.

### CROSS-REFERENCE TO RELATED APPLICATIONS

This is a Continuation Application of PCT Application No. PCT/JP03/16959, filed Dec. 26, 2003, which was published under PCT Article 21(2) in English.

This application is based upon and claims the benefit of priority from prior Japanese Patent Application No. 2002-382374, filed Dec. 27, 2002, the entire contents of which are incorporated herein by reference.

### BACKGROUND OF THE INVENTION

1. Field of the Invention

The present invention relates to an electronic device manufacture support apparatus, a manufacture client terminal device, and a recording medium.

2. Description of the Related Art

Multimedia electronic devices incorporating a plurality of electronic contents data are widely manufactured and distributed recently, such as electronic dictionary, electronic wordbook, electronic encyclopedia, electronic English conversation book, electronic textbook and electronic book. In these electronic devices, incorporated electronic contents data and device shapes are determined at the time of manufacture, and consumers select and purchase specific electronic devices incorporating desired electronic contents data.

However, an electronic device incorporating all desired electronic contents data for a specific customer may not be manufactured and distributed. Though all desired electronic contents data for a customer are incorporated, other unnecessary electronic contents data may be additionally incorporated in the available electronic devices.

Hence it has been demanded to develop a system for allowing the customer (manufacture client) to customize the own specification of the electronic device and the manufacturer to manufacture and distribute the electronic device suited to the specification customized by the customer. To realize this demand, for example, a electronic notebook ordering system has been proposed, in which the manufacturer receives information about the specification customized by the customer through the network, and manufactures the electronic notebook according to the specification.

However, in the case of the electronic device which changes in key allocation on a keyboard depending on the incorporated electronic contents data, since marking on the keyboard varies depending on the selection of the electronic contents data, it is hard to manufacture a customized electronic device only by using the ordering system.

That is, in the case of this electronic device, both the software and hardware specifications must be customized depending on the selected electronic contents data, and such operation cannot be executed easily and automatically in the existing system.

### BRIEF SUMMARY OF THE INVENTION

It is an object of the invention to provide an electronic device manufacture support apparatus, a manufacture client terminal device, and a recording medium capable of manufacturing customized electronic devices easily and automatically.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the present invention and, together with the general description given above and the detailed description of the preferred embodiments given below, serve to explain the principles of the present invention in which:

FIG. 1 is a schematic diagram of an electronic device manufacture support system according to a first embodiment of the invention;

FIG. 2 is a block diagram of a manufacture support server of the first embodiment;

FIG. 3 is a block diagram of a communication device of the first embodiment;

FIG. 4 is a schematic diagram of an electronic dictionary of the first embodiment;

FIG. 5 is an explanatory diagram of a configuration in a recording medium of the first embodiment;

FIG. 6 is a flowchart explaining the flow of order of an electronic dictionary of the first embodiment;

FIG. 7 is a flowchart explaining the first half of a customization select process of the first embodiment;

FIG. 8 is a flowchart explaining the second half of the customization select process of the first embodiment;

FIG. 9 is a flowchart explaining a dictionary select process of the first embodiment;

FIGS. 10A and 10B are display examples of a display unit of the communication device of the first embodiment, wherein FIG. 10A shows a main page of home page and FIG. 10B is a display example when setting start icon is clicked on the main page;

FIG. 11 is a display example of the display unit of the communication device when English-Japanese dictionary is selected in the first embodiment;

FIG. 12 is a display example of the display unit of the communication device when other language dictionary is selected in the first embodiment;

FIG. 13 is a display example of the display unit of the communication device when an appendix dictionary is selected in the first embodiment;

FIG. 14 is a display example of the display unit of the communication device when an electronic dictionary is ordered in the first embodiment;

FIG. 15 is a flowchart explaining the first half of a case print data creating process in laser marking in the first embodiment;

FIG. 16 is a flowchart explaining the second half of the case print data creating process in laser marking in the first embodiment;

FIG. 17 is a diagram explaining a marking contents table of the first embodiment;

FIG. 18 is a diagram explaining a marking position table of the first embodiment;

FIG. 19 is a flowchart explaining a key print data creating process in laser marking in the first embodiment;

FIG. 20 is a diagram showing an example of ordinary case print and key print by laser marking in the first embodiment;

FIG. 21 is a diagram showing an example of case print and key print by laser marking in the first embodiment;

FIG. 22 is a diagram showing an example of dictionary select key print by laser marking in the first embodiment;

FIG. 23 is a diagram showing data written in an electronic dictionary of the first embodiment;

FIG. 24 is a flowchart showing instructions of production of an electronic dictionary in the first embodiment;

FIG. 25 is a block diagram of a manufacture support server according to a second embodiment of the invention;

FIG. 26 is a block diagram of a communication device of the second embodiment;

FIGS. 27A and 27B are diagrams explaining a configuration in a recording medium in the second embodiment, wherein FIG. 27A explains a region and FIG. 27B explains the detail of a recording region for electronic dictionary data;

FIG. 28 is a flowchart explaining the first half of a customization select process in the second embodiment;

FIG. 29 is a flowchart explaining the second half of the customization select process of the second embodiment;

FIG. 30 is a flowchart explaining a dictionary select process of the second embodiment;

FIGS. 31A and 31B are display examples of a display unit of the communication device of the second embodiment, wherein FIG. 31A shows a main page of home page and FIG. 31B is a display example when setting start icon is clicked on the main page; and

FIGS. 32A and 32B show examples of dictionary select key print by laser marking in the second embodiment, wherein FIG. 32A shows the first language is Japanese and FIG. 32B shows the first language is Korean.

### DETAILED DESCRIPTION OF THE INVENTION

A manufacture client terminal device and an electronic device manufacture support apparatus according to the invention are described in detail below. In the embodiments, electronic dictionaries are explained as examples of electronic devices to be manufactured.

### FIRST EMBODIMENT

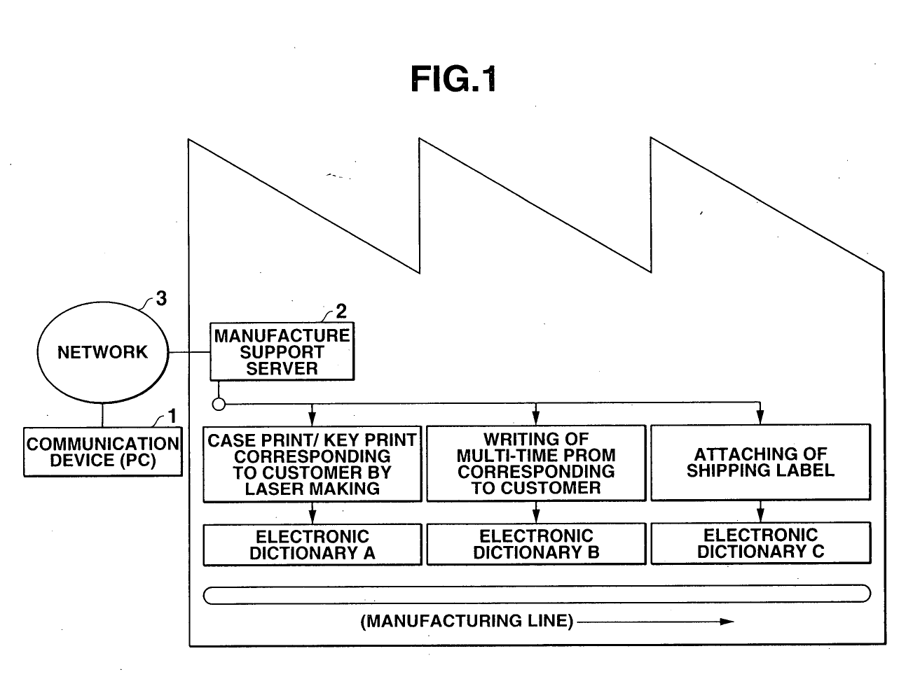

As shown in FIG. 1, an electronic device manufacture support system 100 comprises a communication device 1 as a manufacture client terminal device possessed by a customer, and a manufacture support server 2 as an electronic device manufacture support apparatus possessed by a manufacturer of electronic dictionaries, which are connected together by means of a network 3.

The electronic device manufacture support system 100 supports manufacture of an actual customized electronic dictionary corresponding to the specification of an electronic dictionary selected by the customer on the basis of electronic device image display on the home page of the manufacturer opened on the network 3.

The communication device 1 is a personal computer, PDA (personal digital assistant) or the like possessed by the customer. The customer selects the hardware of the electronic dictionary or type of the electronic dictionary to be mounted on an electronic dictionary image displayed on a screen of the communication device 1, and orders an original customized electronic dictionary of the customer to the manufacturer.

The internal structure of the communication device 1 will be explained.

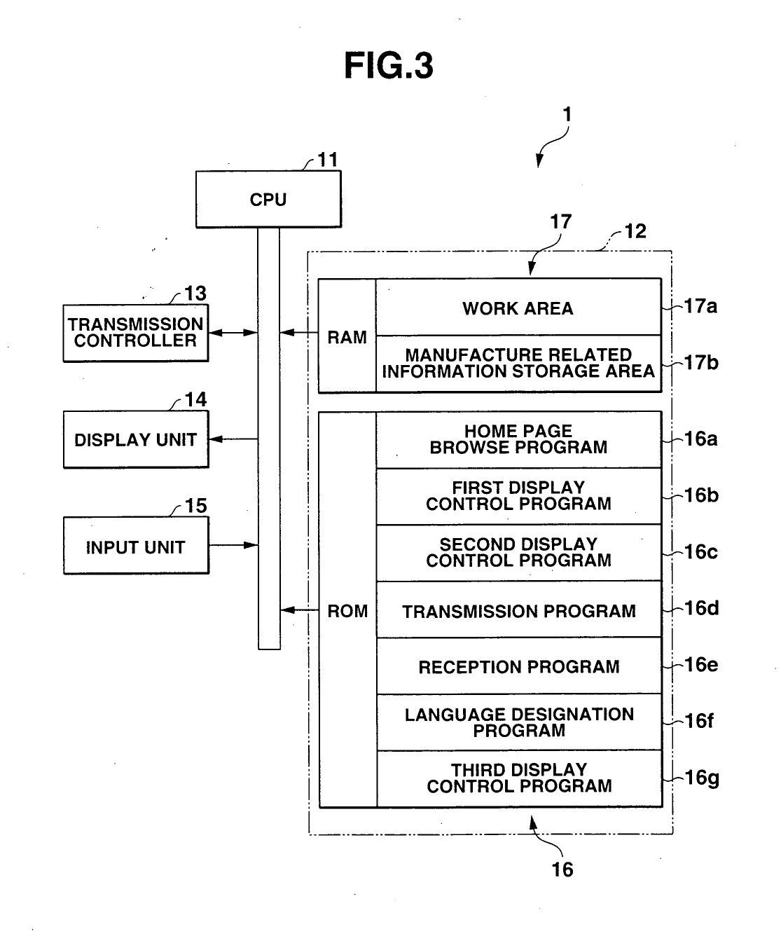

The communication device 1 mainly comprises, as shown in FIG. 3, a CPU 11 for executing system programs and the like necessary for controlling the units, a memory 12 used as work area of the CPU 11, the memory having system programs and the like stored therein, a transmission controller 13 for receiving manufacture related information about the electronic dictionary from the manufacturer's manufacture support server 2 by way of the network 3, a display unit 14 for displaying manufacturer's home page and various data, and an input unit 15 for inputting instructions of operation of the communication device 1.

The CPU 11 reads out the program stored in a ROM 16 in the memory 12, develops into a RAM 17 in the memory 12, and controls instructions or the like to necessary units according to the program.

Specifically, the CPU 11 functions as first display controlling means for displaying electronic dictionary images having select keys on which plural electronic dictionary names are displayed. The CPU 11 functions as language specifying means for specifying a language desired to be used among plural displayed languages, and also functions as second display controlling means for changing over the electronic dictionary name displayed on the surface of the specified select key sequentially to another electronic dictionary name every time any one of the displayed plural select keys is specified, and displaying the newly changed electronic dictionary name. The CPU 11 also functions as third display controlling means for changing over the key operation name displayed on the surface of the specified select key sequentially to another key operation name every time any one of the displayed plural select keys is specified, and displaying the newly changed key operation name.

The memory 12 forms the work area of the CPU 11, and comprises the RAM 17 for temporarily storing the data received from the manufacture support server 2 under the control of the CPU 11, and the ROM 16 having the system programs and the like of the communication device 1 stored therein.

The RAM 17 comprises a work area 17a, a manufacture related information storage area 17b for storing information of hardware of an electronic dictionary transmitted from the manufacture support server 2 and manufacture related information such as a dictionary name of the electronic dictionary, and the like.

The ROM 16 comprises a home page information browse program 16a for browsing home page information for ordering an electronic dictionary, a first display control program 16b for displaying electronic dictionary images having select keys on which plural electronic dictionary names are displayed, a second display control program 16c for changing over the electronic dictionary name displayed on the surface of the specified select key sequentially to another electronic dictionary name every time any one of the displayed plural select keys is selected, and displaying the newly changed dictionary name, a transmission program 16d for transmitting the changed and displayed key operation name to the manufacture support server 2, a reception program 16e for receiving manufacture related information about an electronic device image having the select key corresponding to the key operation name transmitted from the manufacture support server 2 or an actual electronic dictionary corresponding to the electronic device image, a language specifying program 16f for specifying a language desired to be used among plural languages displayed by the control of the first display control program 16b, and a third display control program 16g for changing over the key operation name displayed on the surface of the specified select key sequentially to another key operation name every time any one of the plural select keys displayed is specified by the control of the second display control program 16c, and displaying the newly changed key operation name.

The transmission controller 13 comprises a modem, a terminal adapter, a router, and the like, is connected to the network 3, and transmits/receives data to/from the manufacture support server 2.

Specifically, the transmission controller 13 functions as transmitting means for transmitting the other electronic dictionary name changed over from the displayed electronic dictionary name toward the manufacture support server 2.

The transmission controller 13, after transmitting the electronic dictionary name selected by the customer to the manufacture support server 2, also functions as receiving means for receiving an electronic device image having the select key corresponding to the transmitted electronic dictionary name or manufacture related information relating to an actual electronic dictionary corresponding to the electronic dictionary image.

The display unit 14 comprises CRT, LCD or the like, and displays individual information of customers stored in the memory 12 and information of an electronic dictionary ordered by the customer.

The input unit 15 comprises a keyboard, a mouse and the like, and is used by the customer for manipulating the communication device 1.

The manufacture support server 2 opens a home page relating to electronic dictionaries provided by the manufacturer, between the manufacturer and customers, on the Internet. The dictionary name specifying data (key operation name) of the electronic dictionary transmitted from the customer is received, and the electronic dictionary is manufactured according to the dictionary name specifying data.

More specifically, as shown in FIG. 1, the manufacture support server 2 controls the marking process for printing and ornamenting the contents of the dictionary customized by the customer by laser marking on each key of the keyboard of the electronic dictionary flowing in the manufacturing line. The manufacture support server 2 also controls the writing process of the electronic dictionary data for storing the type of the dictionary selected by the customer and the like in the memory 22. The manufacture support server 2 further controls shipping label printing process for attaching a shipping label to a packaged electronic dictionary after manufacture.

The internal structure of the manufacture support server 2 will be explained below.

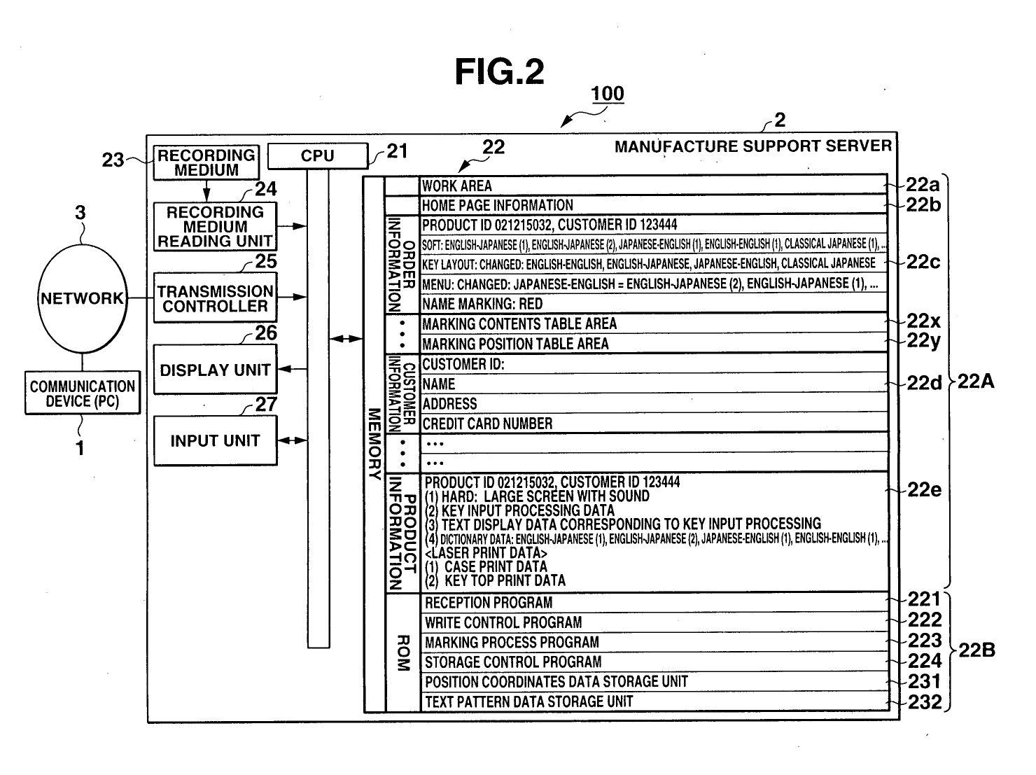

The manufacture support server 2 comprises, as shown in FIG. 2, the CPU 21 for executing system programs and the like necessary for controlling the units, the memory 22 used as a work area of the CPU 21, the memory having stored therein the specification specified by the customer, customer individual information and system programs, a recording medium 23 having stored therein manufacture related information about electronic dictionaries, such as dictionary names, hardware, and keys, a recording medium reading unit 24 for reading the manufacture related information stored in the recording medium 23, a transmission controller 25 for receiving order information from the customer's communication device 1 through the network 3, a display unit 26 for displaying various data, and an input unit 27 for inputting instructions of the operation of the manufacture support server 2.

The CPU 21 reads out the program stored in the memory 22, develops into the work area in the memory 22, and controls instructions to the units according to the program.

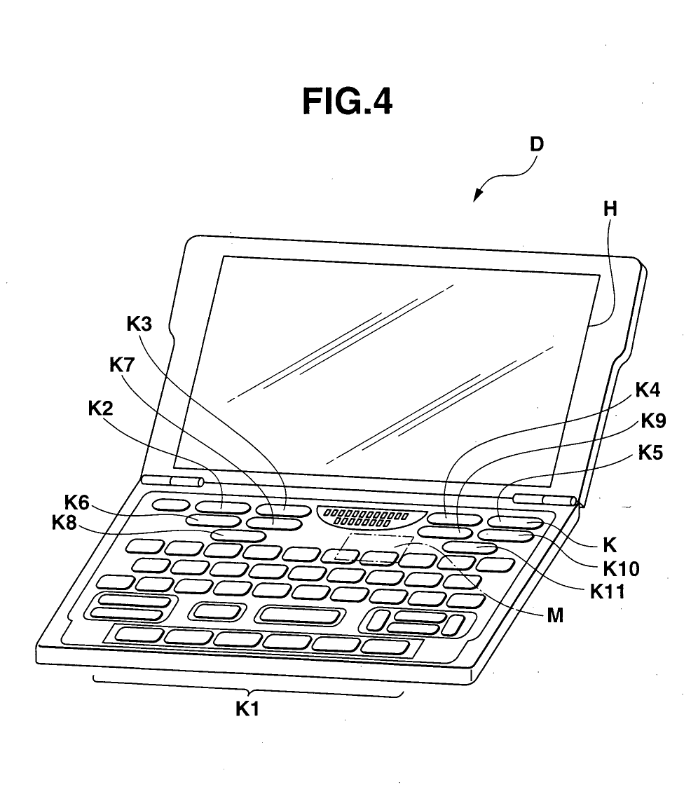

Specifically, the CPU 21 functions as writing controlling means for writing electronic dictionary data prepared corresponding to the received electronic dictionary name into an electronic dictionary memory M (see FIG. 4) provided in an actual electronic dictionary D (see FIG. 4) corresponding to the electronic dictionary image. The CPU 21 functions also as a marking processing unit which controls marking process of a dictionary name corresponding to the surface of the select key in the actual electronic dictionary D corresponding to the received dictionary name.

The CPU 21 also functions as text pattern data reading means for reading out text pattern data corresponding to the received electronic dictionary name from a text pattern data storage region 23b, and further functions as position coordinates data reading means for reading out position coordinates data of the select key for marking the received electronic dictionary name from a coordinates data storage region 23a. Moreover, the CPU 21 functions as marking data creating means for creating marking data on the basis of the read-out text pattern data and position coordinates data. The CPU 21 functions also as key input processing table creating means for creating a key input processing table in which the select key and contents data corresponding to the dictionary name marked in this select key are corresponded with each other, and storing in the electronic dictionary storage unit M provided in the actual electronic dictionary D.

Further, the CPU 21 functions as electronic device image creating means for creating an electronic dictionary image corresponding to electronic dictionary hardware data selected and transmitted by the communication device 1. The CPU 21 functions as unit price reading means for reading out the unit price of the electronic dictionary corresponding to the received dictionary name from the memory 22, and also functions as price calculating means for calculating the price of the actual electronic dictionary D on the basis of the unit prices read out by the unit price reading means. The CPU 21 functions further as accounting means for controlling the accounting of the calculated price. The CPU 21 functions also as name marking processing means for controlling the marking process of marking name data transmitted from the communication device 1 on the surface of the actual electronic dictionary D.

The memory 22 forms the work area of the CPU 21, and comprises a RAM 22A for temporarily storing image data under control of the CPU 21, and a ROM 22B having the program and data for executing the processings stored therein.

The RAM 22A comprises a work area 22a for forming the work area of the CPU 21, a home page information storage area 22b for storing home page information for customizing the electronic dictionary, an order information storage area 22c for storing electronic dictionary data, key layout data and the like read out from the recording medium reading unit 24 depending on specification information of the electronic dictionary determined by the customer, a customer information storage area 22d for storing individual information of customers received from the communication device 1, a product information storage area 22e for storing the electronic dictionary data, key layout data and the like read out from the recording medium reading unit 24 depending on the specification information of the electronic dictionary determined by the customer, a marking contents table area 22x for storing contents to be printed on the key or case, and a marking position table area 22y for storing a position to be printed on the key or case.

The ROM 22B stores therein a reception program 221 for receiving dictionary name designation data transmitted from the communication device 1 every time each dictionary name select key is clicked in the keyboard of the electronic dictionary image displayed in the display unit 14 of the communication device 1, a write control program 222 for reading out electronic dictionary data corresponding to the dictionary name designated by the dictionary name designation data received by the reception program 221, from the recording medium 23, and writing the read-out electronic dictionary data into the electronic dictionary storage unit M provided in the actual electronic dictionary D corresponding to the electronic dictionary image, a marking process program 223 for marking the dictionary name designated by the dictionary name designation data received by the reception program 221 on the surface of the select key of the corresponding actual electronic dictionary D, and a storage control program 224 for storing plural sets of dictionary name and electronic dictionary data with being related to each other in the storage means.

The ROM 22B further includes a position coordinates data storage unit 231, and a text pattern data storage unit 232. The position coordinates data storage unit 231 stores therein the select key of the keyboard in the electronic dictionary image displayed in the communication device 1 and the position coordinates data of the actual electronic dictionary D with being related to each other, and functions as position coordinates data storage means. The text pattern data storage unit 232 stores therein the dictionary name and the text pattern data of this dictionary name with being related to each other, and functions as text pattern data storage means.

The recording medium 23 is, for example, a hard disk, which stores all information in the specification that can be customized in the actual electronic dictionary D, such as dictionary name designation data, electronic dictionary data, and electronic dictionary hardware data.

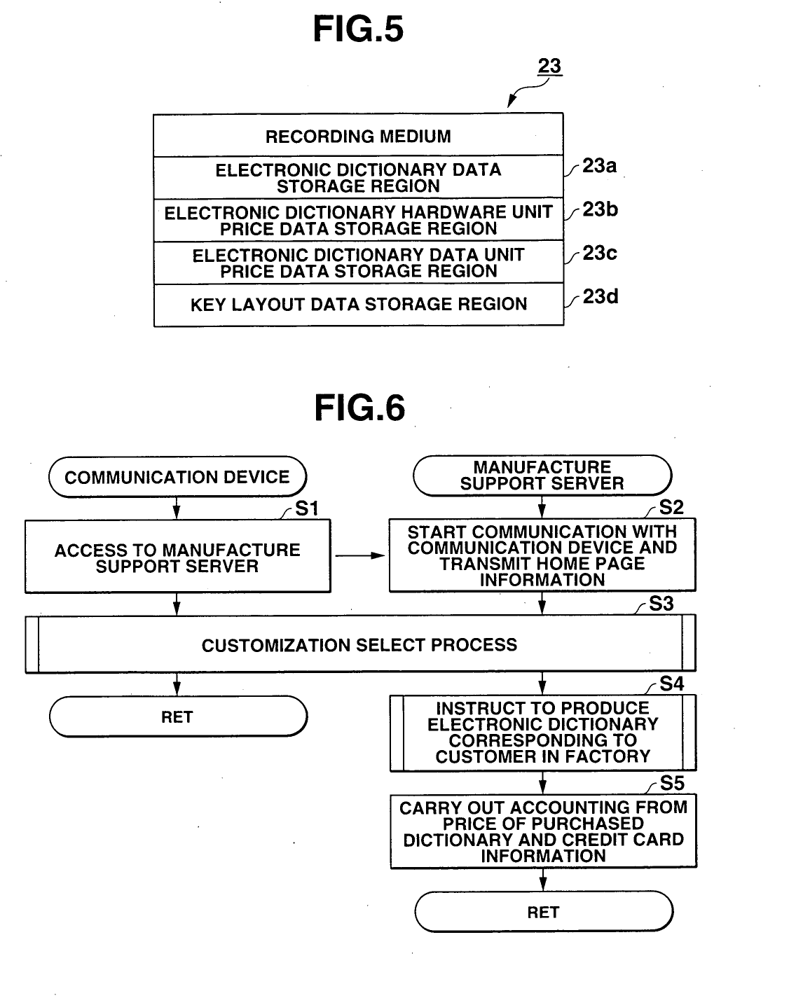

Specifically, as shown in FIG. 5, the recording medium 23 includes an electronic dictionary data storage region 23a, electronic dictionary hardware unit price data storage region 23b, electronic dictionary data unit price data storage region 23c, and a key layout data storage region 23d.

The electronic dictionary data storage region 23a stores plural sets of a dictionary name and electronic dictionary data corresponding to this dictionary name with being related to each other, and functions as storage means.

The electronic dictionary hardware unit price data storage region 23b stores an electronic dictionary hardware name and the unit price of the corresponding electronic dictionary hardware with being related to each other, and functions as first unit price storage means. The electronic dictionary data unit price data storage region 23c stores a dictionary name and the unit price of electronic dictionary data (contents data) corresponding to this dictionary name with being related to each other, and functions as second unit price storage means.

The recording medium reading unit 24 is to read the contents stored in the recording medium 23, and it comprises a known magnetic head or the like, for example, when the recording medium 23 is a hard disk.

The transmission controller 25 comprises a modem, a terminal adapter, a router or the like, and it is connected to the network 3.

Specifically, the transmission controller 25 functions as receiving means for receiving the dictionary name designated data transmitted from the communication device 1. The transmission controller 25 also functions as transmitting means for transmitting the electronic dictionary image to the communication device 1. The transmission controller 25 further functions as price transmitting means for transmitting the calculated price to the communication device 1. The transmission controller 25 functions also as personal name data receiving means for receiving the personal name transmitted from the communication device 1.

The display unit 26 comprises CRT or LCD, and displays the customer individual information, information of an electronic dictionary ordered by the customer and the like, which are stored in the memory 22.

The input unit 27 comprises a keyboard, a mouse and others, and is used by the manufacturer to manipulate the manufacture support server 2.

Manufacture process operation for a customized electronic dictionary by the manufacture support server 2 will be explained by referring to FIGS. 6 to 24.

As shown in FIG. 6, when the customer accesses the home page of electronic dictionaries opened by the manufacture support server 2 from the communication device 1, the CPU 11 of the communication device 1 transmits a presentation request signal of home page information to the manufacture support server 2 by way of the network 3 (step S1). When the transmission controller 25 of the manufacture support server 2 receives the presentation request signal of home page information from the communication device 1, the CPU 21 reads out the home page information from the home page information storage area 22b, and transmits the home page information to the customer's communication device 1 by way of the transmission controller 25 (step S2). The transmission controller 13 of the communication device 1 having received the home page information displays the contents of the home page on the display unit 14.

Customization select process for an electronic dictionary is carried out between the communication device 1 and the manufacture support server 2 (step S3). In this customization select process, specification information of the electronic dictionary customized by the customer is transmitted to the manufacture support server 2, and the manufacture support server 2 acquires order information about the electronic dictionary ordered by the customer on the basis of the received specification information of electronic dictionary.

The CPU 21 confirms purchase information in the memory 22 from the manufacture support server 2, and instructs manufacture of the electronic dictionary corresponding to the customer's specification (step S4).

Finally, the CPU 21 executes an accounting program, and thereby accounts from the price of the dictionary purchased by the customer and credit information (step S5).

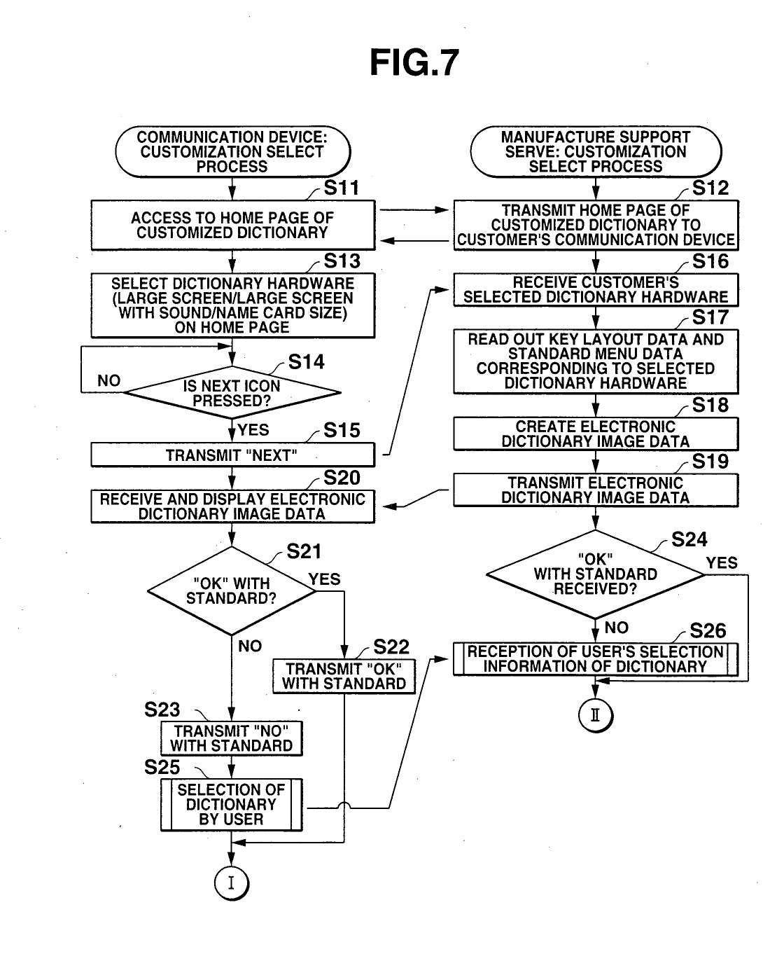

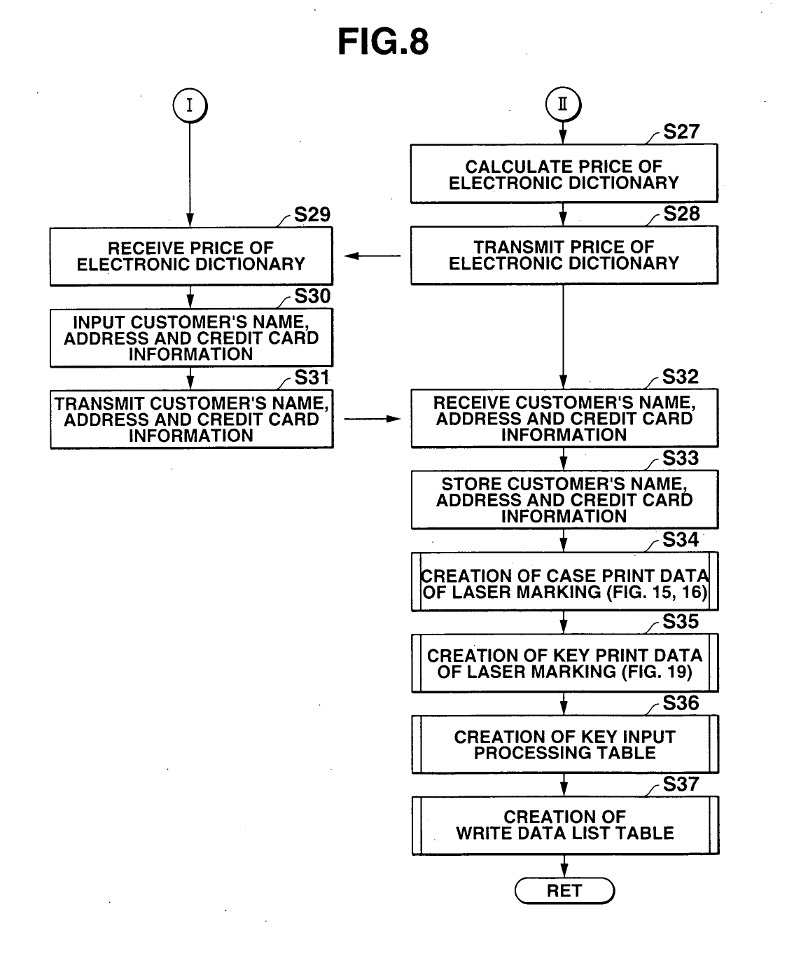

The process of customizing an electronic dictionary will be explained in detail by referring to FIGS. 7 and 8.

As shown in FIGS. 7 and 8, when the customer accesses the home page of customized dictionaries (step S11), the CPU 21 of the manufacture support server 2 reads the home page information from the home page information storage area 22b, and transmits to the communication device 1 by way of the transmission controller 25 (step S12). The customer selects types of the electronic dictionary hardware to be ordered on the home page display on the screen of the display unit 14 of the communication device 1 (step S13). The electronic dictionary hardware refers to, for example, size of a display screen and size of a keyboard.

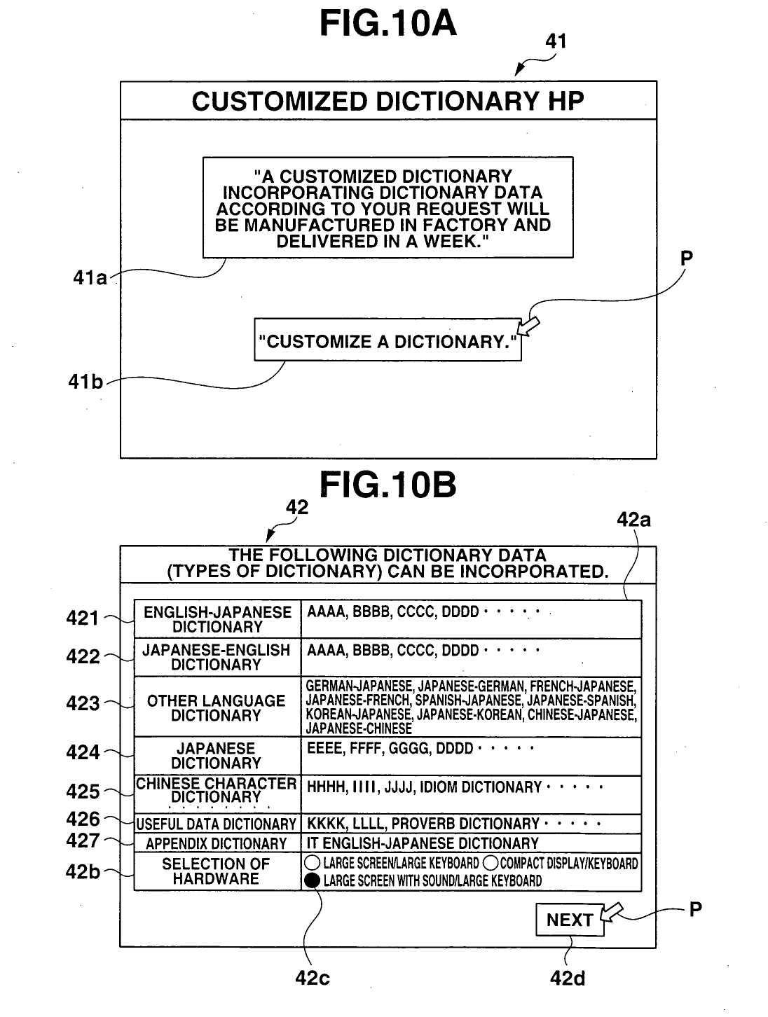

Explaining specific display examples, when the transmission controller 13 of the communication device 1 receives the home page information from the manufacture support server 2, a first display screen 41 as shown in FIG. 10A appears on the display unit 14. The first display screen 41 shows a guide message 41a such as “A customized dictionary incorporating dictionary data according to your request will be manufactured in factory and delivered in a week.” and a setting start icon 41b for setting the specification of a customized dictionary such as “Customize a dictionary.” When the customer clicks the setting start icon 41b by a mouse pointer P, the screen display is changed, and newly shows a second display screen 42 listing up electronic dictionary data that can be customized and electronic dictionary hardware.

The second display screen 42 displays an electronic dictionary data list 421 indicating types of available dictionaries, such as English-Japanese dictionary 421, Japanese-English dictionary 422, other language dictionary 423, Japanese dictionary 424, Chinese character dictionary 425, useful data dictionary 426 and appendix dictionary 427. The electronic dictionary data list 42a further shows plural dictionary names in each type of dictionary, and available dictionary names are opened to the customer. For example, English-Japanese dictionaries include “AAAAA”, “BBBBB”, “CCCCC”, “DDDDD”, etc.

The second display screen 42 includes an electronic dictionary hardware display 42b displaying, together with types of dictionary data, types of electronic dictionary hardware, such as “large screen/large keyboard,” “compact display/keyboard,” and “large screen with sound/large keyboard”. By clicking a select button 42c provided at the beginning of each type of hardware, the type of the electronic dictionary hardware is selected. In FIG. 10B, for example, as the type of electronic dictionary hardware, “large screen with sound/large keyboard” is selected.

After the dictionary hardware is selected by the customer, the CPU 11 of the communication device 1 determines whether or not the customer has clicked a next icon 42 on the second display screen 42 (step S14). When the next icon 42d is clicked (Yes in step S14), the CPU 11 of the communication device 1 transmits a signal for changing over the second display screen 42 to a third display screen 43 to the manufacture support server 2 (step S15). When the next icon 42 is not clicked (No in step S14), the process returns back to step S14, determination in step S14 is repeated until the next icon 42 is clicked.

When the customer clicks the select button 42c for the type of electronic dictionary hardware, the CPU 11 of the communication device 1 transmits electronic dictionary hardware information showing the clicked type of electronic dictionary hardware to the manufacture support server 2 by way of the transmission controller 13, and the transmission controller 25 of the manufacture support server 2 receives the pertinent electronic dictionary hardware information (step S16).

In step S16, when the CPU 11 of the communication device 1 transmits the signal for changing over the second display screen 42 to a third display screen 43 to the manufacture support server 2, the CPU 21 of the manufacture support server 2 reads out the key layout and standard menu corresponding to the received electronic dictionary hardware data from the recording medium 23 (step S17).

The standard menu is customized by the manufacturer and stored in the recording medium 23. Specific examples are “Japanese dictionary”, “English-Japanese dictionary” and others common ones.

The CPU 21 creates electronic dictionary image data in which the key layout corresponding to the electronic dictionary hardware and standard dictionary menu are displayed (step S18).

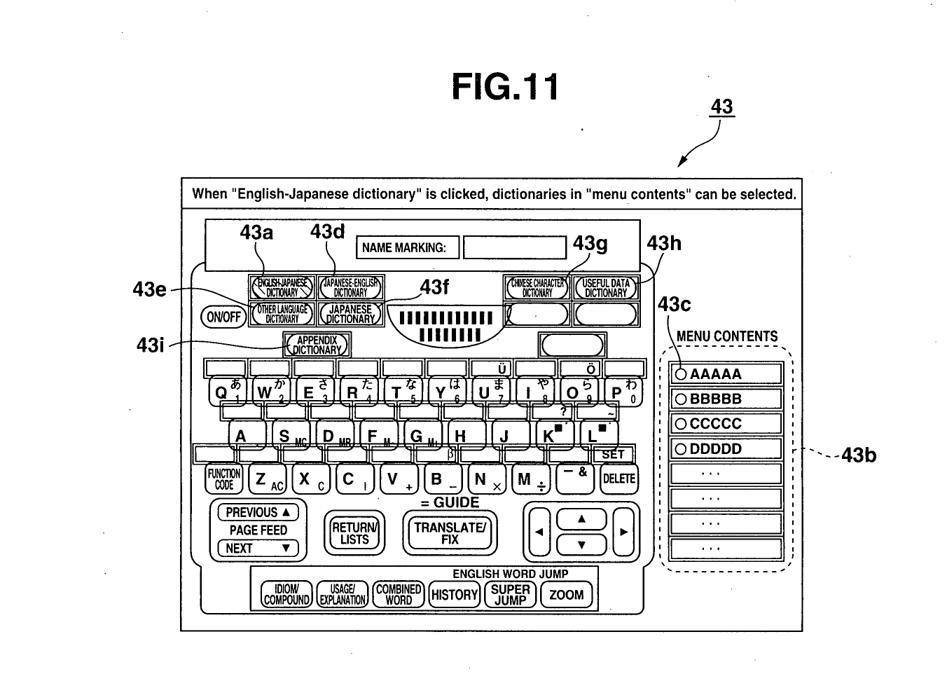

The CPU 21 transmits the created electronic dictionary image data to the communication device 1 by way of the transmission controller 25 (step S19). The transmission controller 13 of the communication device 1 which has received the electronic dictionary image data having the key layout and standard menu displayed therein displays the electronic dictionary image based on the electronic dictionary image data on the display unit 14 as the third display screen 43 as shown in FIG. 11 (step S20). This electronic dictionary image shows the icon asking the customer whether satisfied with the standard menu or not.

FIG. 11 is the image after clicking the icon, and hence the icon is not shown.

When the customer clicks the OK icon (Yes in step S21), the CPU 11 of the communication device 1 transmits an OK signal to the manufacture support server 2 (step S22), and dictionary is not selected. If the customer clicks the NO icon (No in step S21), the CPU 11 of the communication device 1 transmits a No signal to the manufacture support server 2 (step S23).

In the manufacture support server 2, it is determined whether or not the OK signal of the standard menu is received from the communication device 1 (step S24). When the CPU 21 determines that the OK signal is received (Yes in step S24), the price of the electronic dictionary is calculated (step S27). On the other hand, when the transmission controller 25 receives the No signal (No in step S24), the electronic dictionary data to be mounted is selected (step S26).

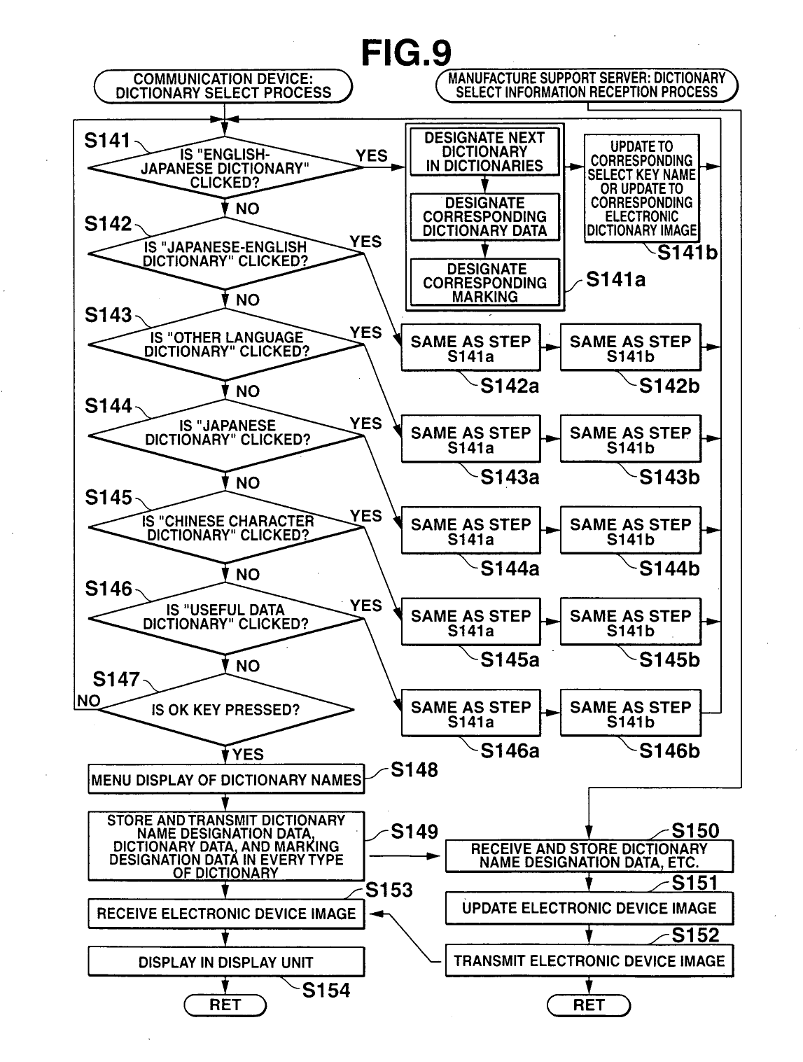

Selection of an electronic dictionary to be mounted will be explained by referring to FIG. 9.

As shown in FIG. 9, the CPU 11 of the communication device 1 determines whether or not the customer has manipulated a select key 43a (see FIG. 11) displaying “English-Japanese dictionary” (step S141). When the CPU 11 determines that the customer has manipulated the select key 43a of “English-Japanese dictionary” (Yes in step S141), a next electronic dictionary name (for example, “AAAAA”) among the dictionaries is designated, and this dictionary name designation data is stored in the manufacture related information area 17b in the RAM 17. The dictionary contents corresponding to this next dictionary are designated, and the designated electronic dictionary data is stored in the manufacture related information area 17b in the same RAM 17. Marking process corresponding to the next dictionary is designated, and the marking designation data is also stored in the manufacture related information area 17b of the RAM 17 (step S141a).

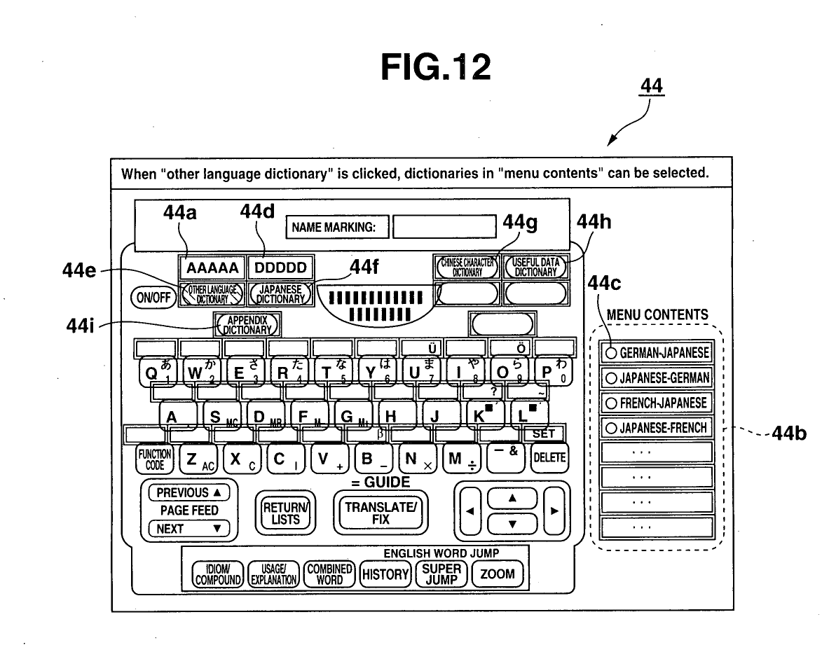

The CPU 11 updates to (replaces) an image of a portion of a select key 44a showing the select key name (for example, select key name “AAAAA”) corresponding to the next electronic dictionary name selected in step S141. Or the CPU 11 updates to (replaces) the entire electronic dictionary image (for example, electronic dictionary image “AAAAA”) in which the electronic dictionary name selected in step S141 is displayed in the select key 44a (step S141b; see FIG. 12).

The CPU 11 determines whether or not the customer has manipulated the select key 44a showing the updated select key name (for example, select key name “AAAAA”) (step S141). When the CPU 11 determines that the customer has manipulated the select key 44a of “English-Japanese dictionary” (Yes in step S141), further next electronic dictionary name (for example, “BBBBB”) among the dictionaries is designated, and this dictionary name designation data is stored in the manufacture related information area 17b in the RAM 17. The dictionary contents corresponding to this next dictionary are designated, and the designated electronic dictionary data is stored in the manufacture related information area 17b in the same RAM 17. Marking process corresponding to the next dictionary is designated, and the marking designation data is also stored in the manufacture related information area 17b of the RAM 17 (step S141a).

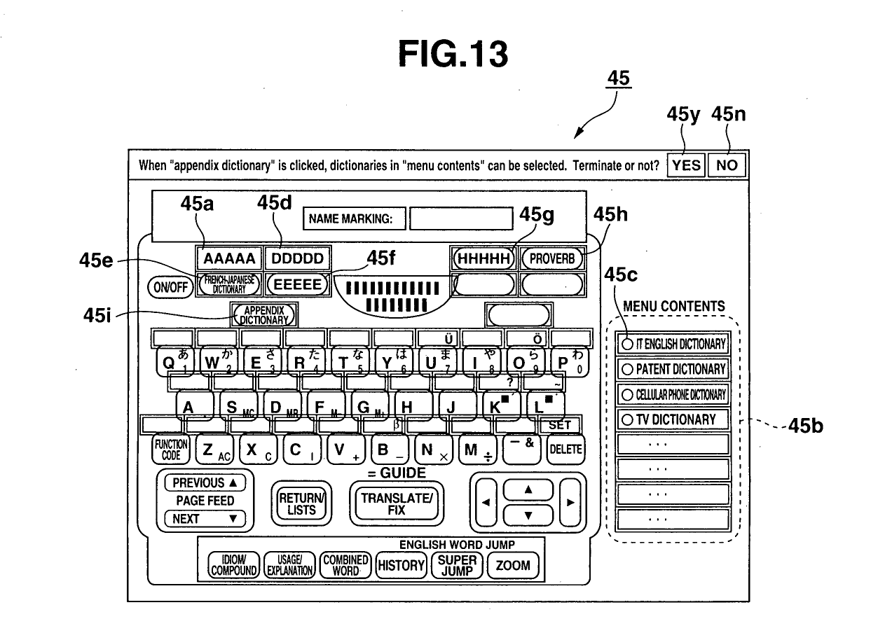

The CPU 11 updates to an image of a portion of a select key 45a showing the select key name (for example, select key name “BBBBB”) corresponding to the next electronic dictionary name selected in step S141. Or the CPU 11 updates to the electronic dictionary image (for example, electronic dictionary image “BBBBB”) in which the electronic dictionary name selected in step S141 is displayed in the select key 45a (step S141b; see FIG. 13).

In this manner, every time the select keys 43a, 44a, . . . displaying “English-Japanese dictionary” are manipulated, the dictionary name designation data corresponding to the next electronic dictionary name among dictionaries of “English-Japanese dictionary”, corresponding dictionary contents data designation data, and corresponding marking designation data are stored in the manufacture related information area 17b in the RAM 17, while only the image of the portion of the select key in which the select key name corresponding to the selected next electronic dictionary name is displayed, or the entire electronic dictionary in which the selected electronic dictionary name is displayed in the select key is updated (steps S141, S141a, S141b). As a result, any one of electronic dictionaries “AAAAA”, “BBBBB”, “CCCCC”, “DDDDD”, etc. can be changed over and displayed. In this embodiment, after the final electronic dictionary name (for example, “DDDDD”) among the stored electronic dictionary names, the first electronic dictionary name (for example, “AAAAA”) is displayed.

When it is determined that, instead of manipulating the select key 43a of “English-Japanese dictionary”, the customer manipulates a select key 43d of “Japanese-English dictionary” as shown in FIG. 11 (Yes in step S142), the CPU 11 designates a next electronic dictionary name (for example, “AAAAA”) among the dictionaries, and stores this dictionary name designation data in the manufacture related information area 17b in the RAM 17. The dictionary contents corresponding to this next dictionary are designated, and the designated electronic dictionary data is stored in the manufacture related information area 17b in the same RAM 17. Marking process corresponding to the next dictionary is designated, and the marking designation data is also stored in the manufacture related information area 17b of the RAM 17 (step S142a).

The CPU 11 updates to an image of a select key showing the select key name (for example, select key name “AAAAA”) corresponding to the next electronic dictionary name selected in step S142. Or the CPU 11 updates to the entire electronic dictionary image (for example, electronic dictionary image “AAAAA”) in which the electronic dictionary name selected in step S142 is displayed in the select key (step S142b).

The CPU 11 determines whether or not the customer has manipulated the select key 43d showing the updated select key name (for example, select key name “AAAAA”) (step S142). When the CPU 11 determines that the customer has manipulated the select key 43d of “Japanese-English dictionary” (Yes in step S142), further next electronic dictionary name (for example, “BBBBB”) among the dictionaries is designated, and this dictionary name designation data is stored in the manufacture related information area 17b in the RAM 17. The dictionary contents corresponding to this next dictionary are designated, and the designated electronic dictionary data is stored in the manufacture related information area 17b in the same RAM 17. Marking process corresponding to the next dictionary is designated, and the marking designation data is also stored in the manufacture related information area 17b of the RAM 17 (step S142a).

The CPU 11 updates to the select key name (for example, select key name “BBBBB”) corresponding to the next electronic dictionary name selected in step S142. Or the CPU 11 updates to the electronic dictionary image (for example, electronic dictionary image “BBBBB”) in which the electronic dictionary name selected in step S142 is displayed in the select key (step S142b).

In this manner, every time the select keys displaying “Japanese-English dictionary” are manipulated, the dictionary name designation data corresponding to the next electronic dictionary name among dictionaries of “Japanese-English dictionary”, corresponding dictionary contents data designation data, and corresponding marking designation data are stored in the manufacture related information area 17b in the RAM 17, while the electronic dictionary image in which the select key name corresponding to the selected next electronic dictionary name, or the selected electronic dictionary name is displayed in the select key is updated (steps S142, S142a and S142b). As a result, any one of electronic dictionaries “AAAAA”, “BBBBB”, “CCCCC”, “DDDDD”, etc. can be changed over and displayed.

Hereinafter, the same procedure is repeated in the sequence of “other language dictionary”, “Japanese dictionary”, “Chinese character dictionary”, “useful data dictionary” and “appendix dictionary” until the OK key is manipulated by the customer in step S147 (steps S143 to S146), and information of selected types of electronic dictionaries are stored in the manufacture related information area 17b.

When the CPU 11 determines that the customer has manipulated the “OK key” in step S147, the menu contents of available electronic dictionary data are shown in the display unit 14 (step S148).

The CPU 11 transmits the dictionary name designation data, electronic dictionary data, and marking designation data stored in the manufacture related information area 17b to the manufacture support server 2 (step S149). The manufacture support server 2 receives the transmitted dictionary name designation data, electronic dictionary data, and marking designation data at the transmission controller 25, and the CPU 21 stores in specified storage regions in the order information area 22c and marking contents table area 22x in the memory 22 (step S150).

The CPU 21 in the manufacture support server 2 reads out the electronic dictionary name designated by the transmitted dictionary name designation data from the text pattern data storage unit 232, and updates to the electronic dictionary image in which the read-out electronic dictionary name is displayed in the select key (step S151), and the updated electronic dictionary image is transmitted to the communication device 1 (step S152). The communication device 1 receives the updated electronic dictionary image (step S153), and displays the image in the display unit 14 (step S154).

A specific example of selecting an electronic dictionary will be explained by referring to FIGS. 11 to 13.

In step S20 shown in FIG. 7, when the electronic device image as shown in FIG. 11 appears on the display unit 14 of the communication device 1, the customer selects a desired type of dictionary to be mounted on the electronic dictionary while observing the screen. FIG. 11 indicates that the customer has clicked the English-Japanese dictionary icon 43a. When the English-Japanese dictionary icon 43a is clicked, a menu list 43b showing all electronic dictionary names of “English-Japanese dictionary” is displayed. In the case of “English-Japanese dictionary”, the menu list 43b shows electronic dictionary names “AAAAA”, “BBBBB”, “CCCCC”, “DDDDD”, etc.

Among dictionary names, the select button 43c corresponding to the first dictionary name in the list is displayed, and then the customer clicks this select button 43c. The display unit 14 of the communication device 1 displays, next to-the English-Japanese dictionary icon 43a, Japanese-English dictionary icon 43d, other language dictionary icon 43e, Japanese dictionary icon 43f, Chinese character dictionary icon 43g, useful data dictionary icon 43h, appendix dictionary icon 43i, etc.

In this procedure, when electronic dictionary names such as “English-Japanese dictionary” and “Japanese-English dictionary” are selected, the English-Japanese dictionary icon 43a and Japanese-English dictionary icon 43d are updated to icons 44a, 44d of selected electronic dictionary data, and the electronic device image is displayed.

FIG. 12 shows a fourth display screen 44 where “AAAAA” is selected as the “English-Japanese dictionary” and “DDDDD” is selected as the “Japanese-English dictionary”, and after selection of electronic dictionaries of English-Japanese dictionary and Japanese-English dictionary, the other language dictionary icon 43e is clicked.

A menu list 44b showing electronic dictionary data of “other language dictionaries” is displayed. In the case of other language dictionaries, the menu list 44b displays electronic dictionary data of “German-Japanese”, “Japanese-German”, “French-Japanese”, “Japanese-French”, etc. At the beginning of each electronic dictionary data, the select button 44c is displayed, and the customer can select electronic dictionary data of the other language dictionary by clicking this select button 44c.

In this procedure, when the electronic dictionary data of the other language dictionary is selected, the display of another language dictionary icon 44e in FIG. 12 is changed to an icon 45e of the selected electronic dictionary data shown in FIG. 13. In FIG. 13, “French-Japanese dictionary” is selected as the other language dictionary. FIG. 13 shows a fifth display screen 45 appearing when the appendix dictionary icon 45e is clicked after selection of electronic dictionary data of English-Japanese dictionary, Japanese-English dictionary, other language dictionary, Japanese dictionary, Chinese character dictionary, and useful data dictionary.

As known from FIG. 13, a Japanese dictionary icon 44f in the fourth display screen 44 in FIG. 12 is updated to an “EEEEE” icon 45f in the fifth display screen 45 in FIG. 13. This is the result of the customer selecting “EEEEE” among electronic dictionary data of Japanese dictionary by clicking the Japanese dictionary icon 44f. Similarly, a Chinese character dictionary icon 44g and a useful data dictionary icon 44h are changed respectively to an “HHHHH” icon 45g and a proverb icon 45h, respectively.

In the fifth display screen 45 in FIG. 13, a menu list 45b showing contents of electronic dictionary data of “appendix dictionary” is shown. In the case of “appendix dictionary”, the menu list 45b shows electronic dictionary data of “IT English dictionary”, “patent dictionary”, “cellular phone dictionary”, “TV dictionary”, etc. At the beginning of each electronic dictionary data, a select button 45c is displayed, and the customer can select the electronic dictionary data of the appendix dictionary by clicking this select button 45c.

In the upper part of the fifth display screen 45, there are select icons 45y, 45n for terminating the dictionary selection or not, that is, “YES” icon 45y and “NO” icon 45n. When the customer clicks the “YES” icon 45y, selection of dictionaries can be terminated.

The select icons 45y, 45n are displayed in the fifth display screen 45, but these icons may be always displayed when selecting dictionary data.

Back to the flowchart in FIG. 7, the CPU 21 of the manufacture support server 2 calculates the price by the electronic dictionary hardware of the customized electronic dictionary and the incorporated electronic dictionary data (step S27).

Specifically, the unit price of the selected electronic dictionary hardware is read out from the electronic dictionary hardware unit price data storage region 23b of the recording medium 23, and the unit price of the selected electronic dictionary data is read out from the electronic dictionary data unit price data storage region 23c of the recording medium 23. On the basis of the unit prices read out, the price of the corresponding electronic dictionary is calculated.

The CPU 21 of the manufacture support server 2 transmits the calculated price to the communication device 1 by way of the transmission controller 25 (step S28).

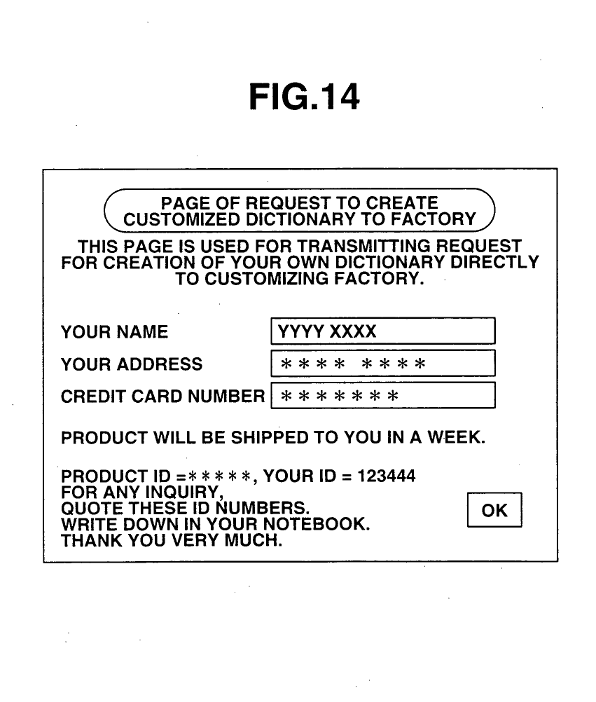

Receiving the price of the electronic dictionary, the communication device 1 displays this price in the display unit 14 (step S29). The customer, who has decided to purchase this electronic dictionary, inputs the name, address, credit information and the like on the home page as shown in FIG. 14 (step S30), and the CPU 11 of the communication device 1 transmits the information to the manufacture support server 2 (step S31). When the transmission controller 25 of the manufacture support server 2 receives the customer's name, address and credit information (step S32), the CPU 21 stores the information as customer information in the specified storage regions in the customer information area 22d and marking contents table area 22x of the memory 22 in correspondence to the purchase information (step S33).

The CPU 21 creates case print data for laser marking of the electronic dictionary case, out of the electronic dictionary hardware (step S34).

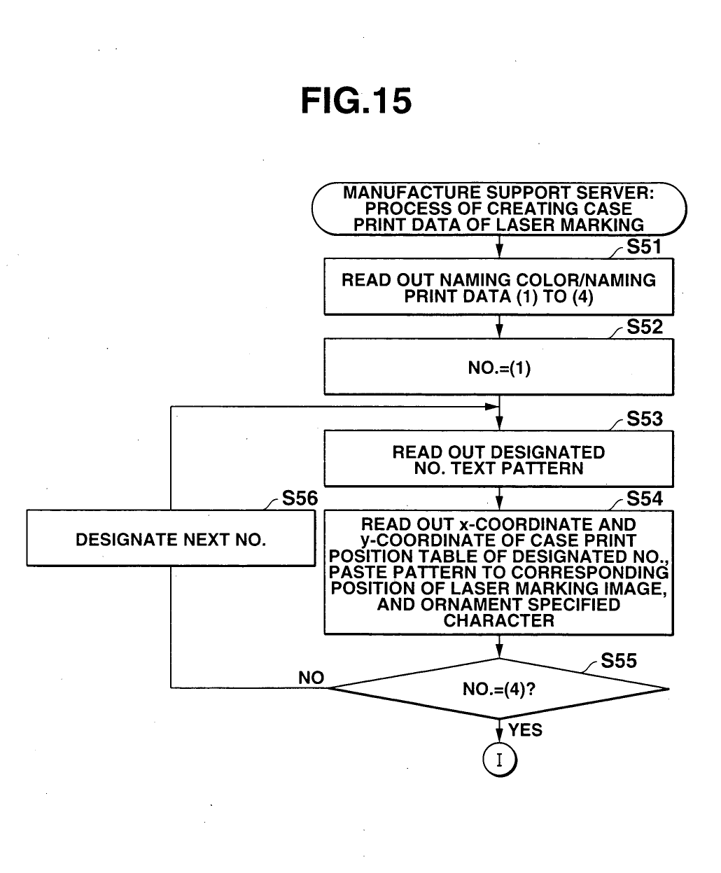

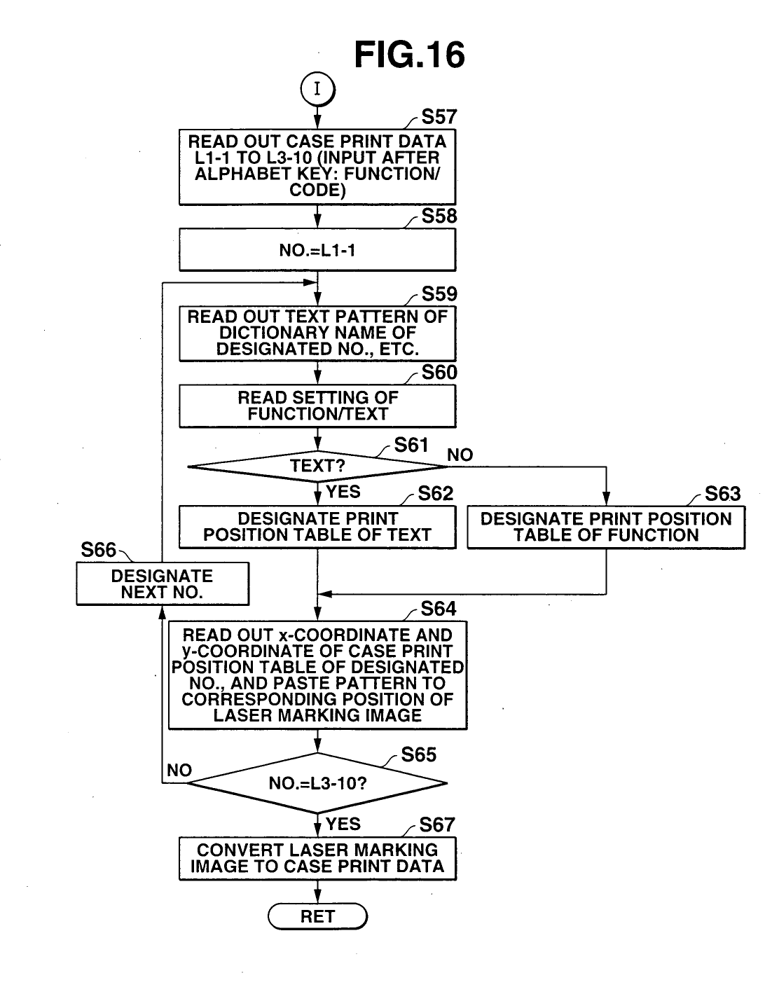

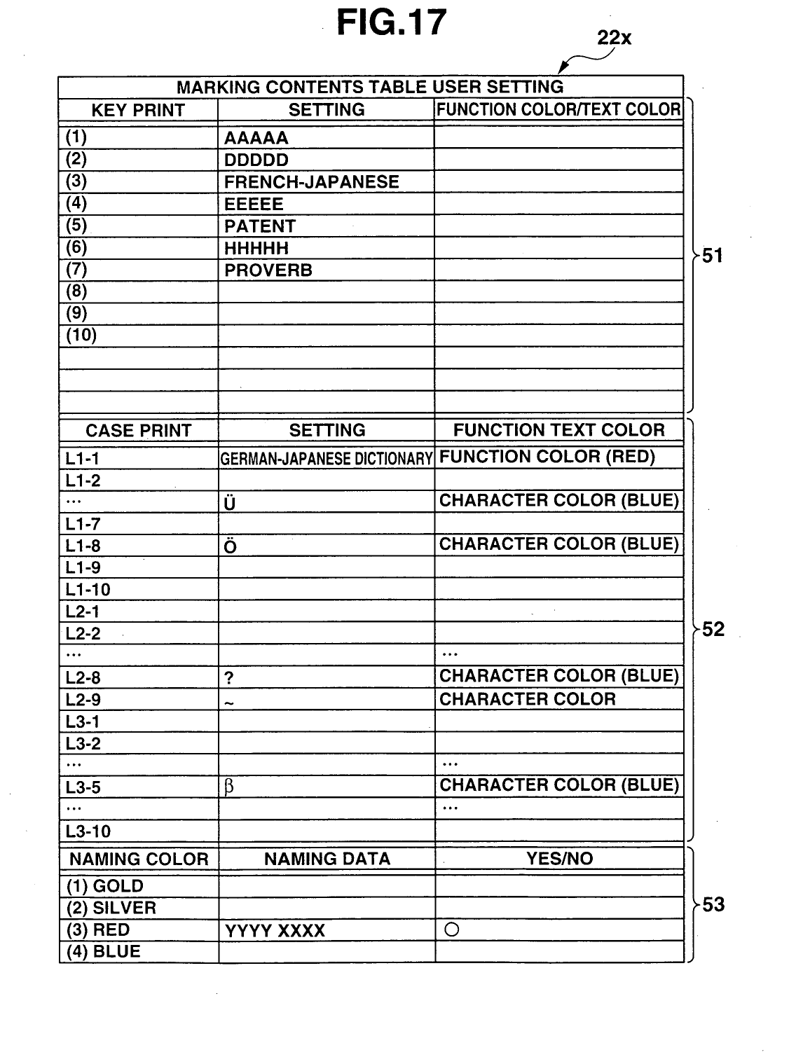

In a specific example, explaining the case print data creating process by referring to the flowcharts in FIGS. 15 and 16, the CPU 21 reads out naming color/naming print data 53 from the marking contents table 22x stored in the memory 22 as shown in FIG. 17 (step S51). The marking contents table 5 shows a corresponding list of marking on the key K of the actual electronic dictionary D and the function of the marked key. In the naming color/naming print data 53, four naming colors (gold, silver, red, blue) are set, and numbers 1 to 4 are assigned sequentially for gold, silver, red and blue. Text pattern (naming data) is set in any specific naming color, and, for example, red (3) is set for customer name “yyyy xxxx”. That is, in the case of marking of the electronic dictionary case, the name of “yyyy xxxx” is marked in red text.

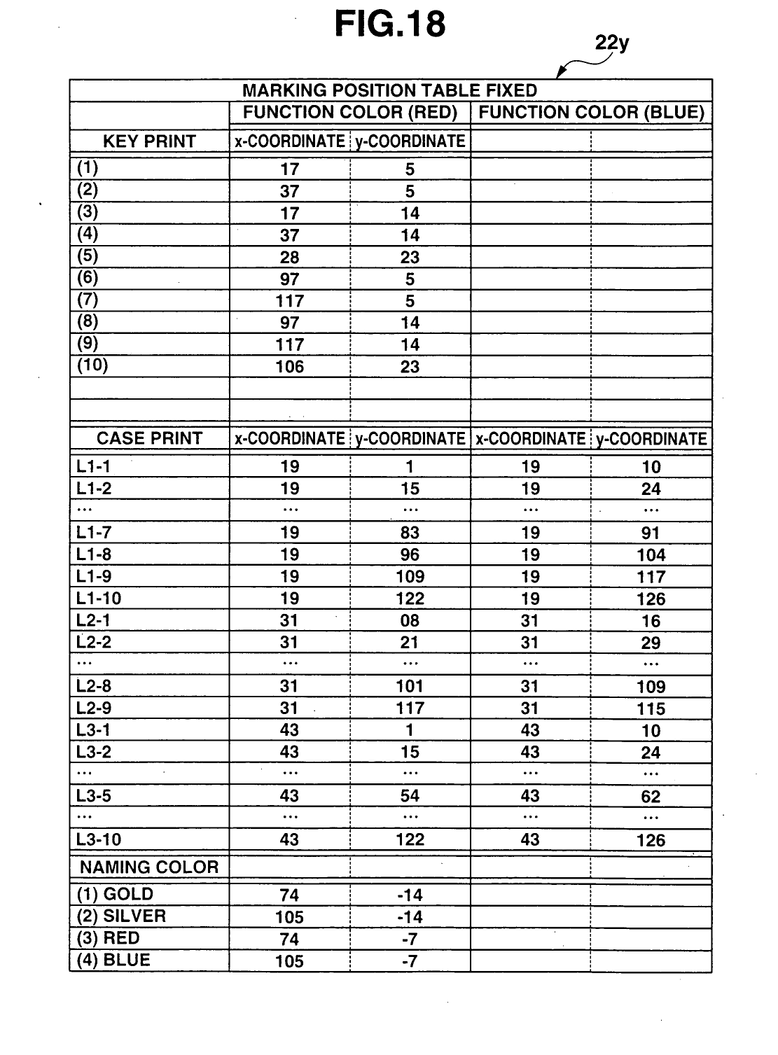

The CPU 21 initializes (sets to 1) a designated number (step S52), and reads out the text pattern of the designated number (step S53). As shown in FIG. 18, the CPU 21 reads out the X-Y coordinates corresponding to the text pattern of the designated number from the marking position table 22y in which the X-Y coordinates in the display unit 14 displayed in the communication device 1 are stored, pastes the text pattern to the corresponding position of the displayed electronic device image, and colors the text pattern (step S54). The marking position table 22y specifies the X-Y coordinates of the key K to be marked.

The CPU 21 determines whether or not the designated number becomes 4 (step S55). When the CPU 21 determines that the designated number is 4 (Yes in step S55), naming is terminated, and the case print data 52 of marking provided around the key K is read out (step S57). When the CPU 21 determines that the designated number is not 4 (No in step S55), a next number is designated (step S56), and the process returns to step S53.

The case print data 52 includes electronic dictionary data and special characters and symbols functioning after alphabet key shifting, and “German-Japanese dictionary” and function color “red” are set in the designate number L1-1. In designated number L2-8, “?” and text color “blue” etc. are set. “Red” is set for the key showing the function and “blue” is set for the color showing the text.

The CPU 21 initializes the designated number (set the designated number to L1-1) (step S57), and reads out the text pattern of the designated number (step S59). As shown in FIG. 18, the CPU 21 reads out the X-Y coordinates corresponding to the text pattern of the designated number from the marking position table 22y in which the X-Y coordinates are stored, and pastes the text pattern to the corresponding position on the displayed electronic device image screen, and ornaments the text pattern. The CPU 21 reads out whether the text pattern of each designated number is function key or text key (step S60). The CPU 21 determines whether or not the read text pattern is for a text key (step S61). When the text pattern is for a text key (Yes in step S61), the CPU 21 designates the X-Y coordinates about the text key of the marking position table 22y (step S62), and when the text pattern is for a function key (No in step S61), the CPU 21 designates the X-Y coordinates about the function key of the marking position table 22y (step S63).

The CPU 21 reads out the X-Y coordinates designated about the text or function corresponding to the text pattern of the designated number from the marking position table 22y in which the X-Y coordinates on the screen displayed in the communication device 1 are stored, pastes the text pattern to the corresponding position of the displayed electronic device image, and ornaments the corresponding text pattern (step S64). The CPU 21 determines whether or not the designated number is L3-10 (step S65). When the CPU 21 determines that the designated number is L3-10 (Yes in step S65), the laser marking image is converted to the print data to be printed (step S67). When the CPU 21 determines that the designated number is not L3-10 (No in step S65), a next number is designated (step S66), and the process returns to step S59.

The CPU 21 creates key print data for laser marking of an electronic dictionary key, out of the electronic dictionary hardware (step S35 in FIG. 8).

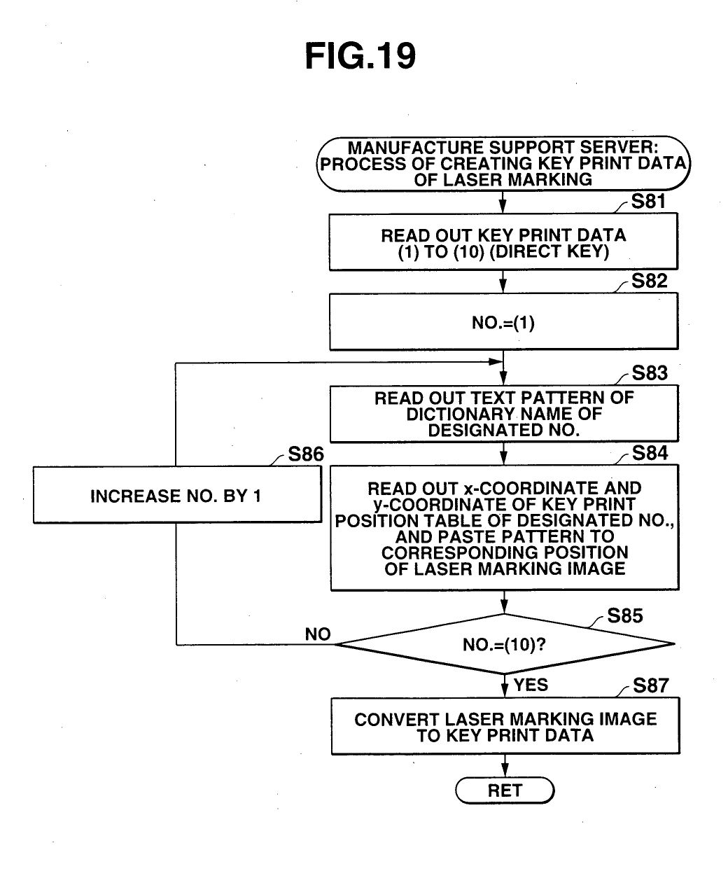

In a specific example, explaining the case print data creating process by referring to the flowchart in FIG. 19, the CPU 21 reads out key print data 51 from the marking contents table 22x stored in the memory 22 as shown in FIG. 17 (step S81).

The CPU 21 initializes a designated number (sets the designated number to 1) (step S82), and reads out the text pattern of a dictionary name of the designated number (step S83). As shown in FIG. 18, the CPU 21 reads out the X-Y coordinates corresponding to the text pattern of the designated number from the marking position table 22y in which the X-Y coordinates are stored, pastes the text pattern to the corresponding position of the displayed electronic device image, and ornaments the text pattern (step S84). The CPU 21 determines whether or not the designated number becomes 10 (step S85). When the CPU 21 determines that the designated number is 10 (Yes in step S85), the key input processing table is created (step S36 in FIG. 8). When the CPU 21 determines that the designated number is not 10 (No in step S85), a next number is designated (step S86), and the process returns to step S83.

The key print data 51 includes seven kinds of electronic dictionary data, and designation numbers 1 to 10 are attached in the sequence of “AAAAA”, “DDDDD”, “French-Japanese”, “EEEEE”, “Patent”, “HHHHH”, and “Proverb”. Designation numbers 8 to 10 are extra keys, and are not printed.

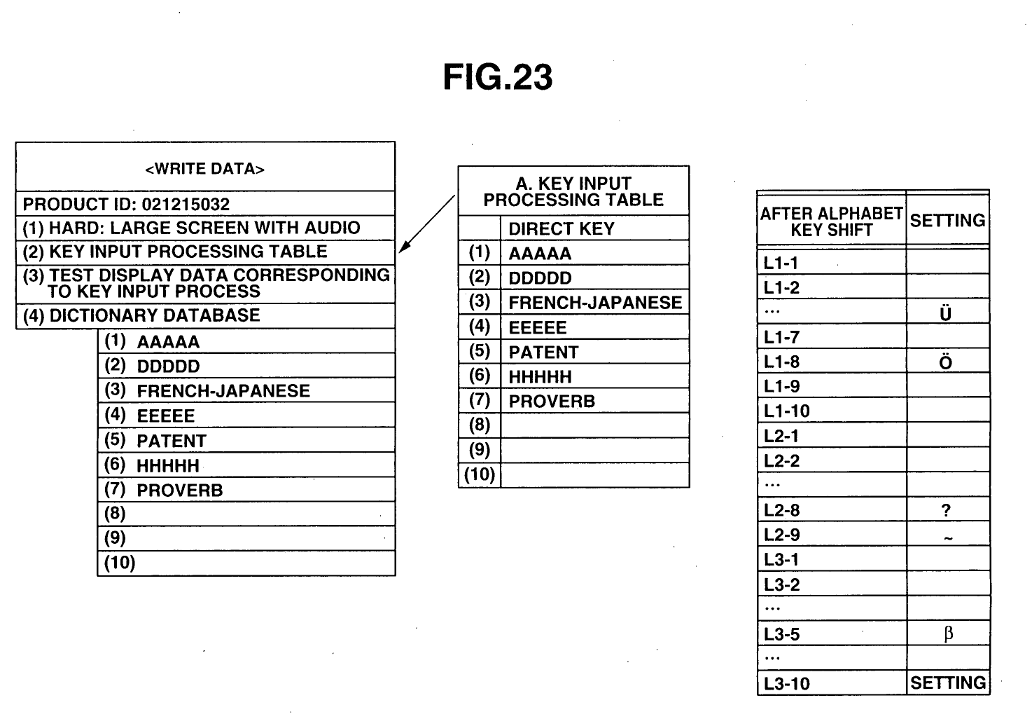

Process of creating a key input processing table, and process of creating a write data list table will be explained by referring to FIG. 23.

The CPU 21 creates the key input processing table on the basis of the data of the marking contents table 22x and marking position table 22y, and stores the data in the product information area 22e of the memory 22. At this time, the designation numbers 1 to 10 and dictionary name data X-Y coordinates are stored with being related to each other.

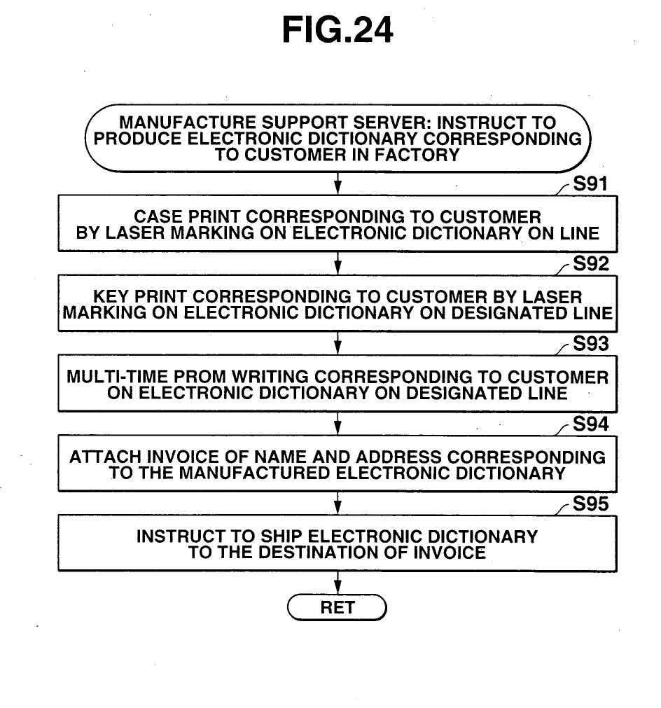

Process of instructing to produce an electronic dictionary corresponding to the customer in the factory will be explained by referring to FIG. 24.

As shown in FIG. 24, according to the information of the electronic dictionary ordered from the manufacture support server 2, the CPU 21 gives an instruction to mark on the dictionary case (step S91).

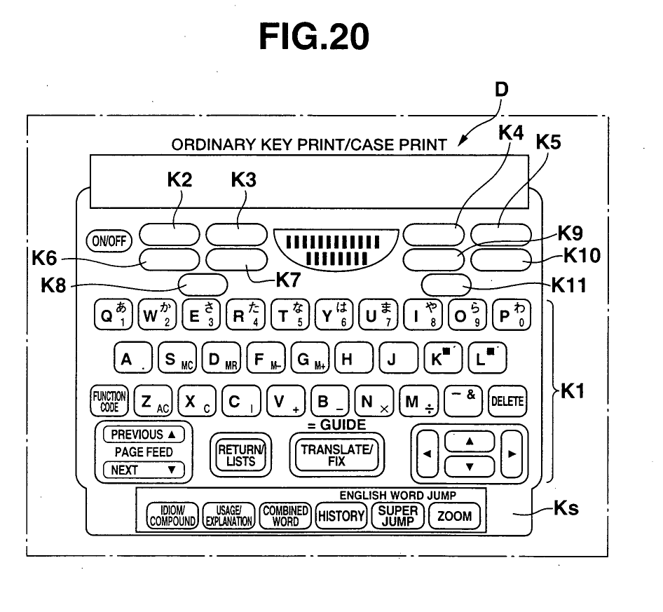

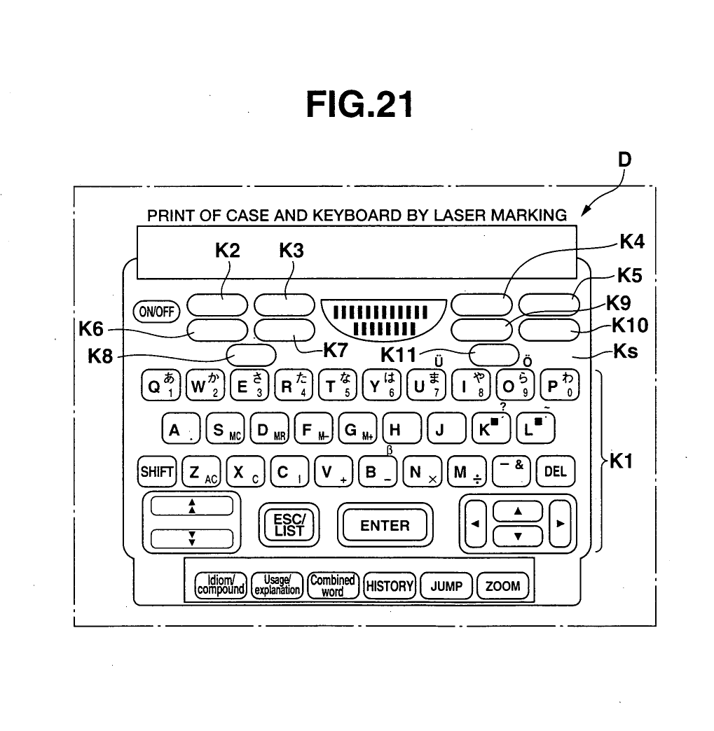

When instructing to mark on the dictionary case, the CPU 21 first executes marking process using known laser beam to the general select keys K1, case KS such as “A”, YVKA”, “SA”, . . . provided on the electronic dictionary shown in FIG. 20. The result of marking process on the actual electronic dictionary D on the basis of the case print data is shown in FIG. 21. As can be confirmed from FIG. 21, marks such as “?”, “˜”, and “setting” are made on the case KS of the actual electronic dictionary D.

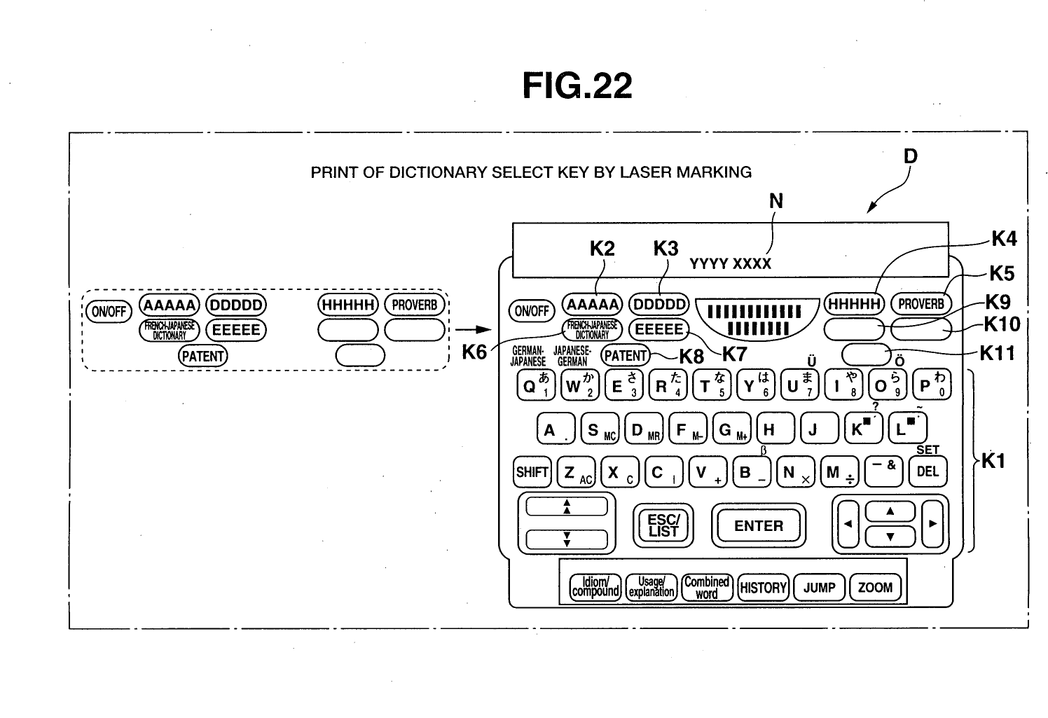

According to the information of the electronic dictionary ordered from the manufacture support server 2, the CPU 21 instructs to mark on the key K (step S92). When instructed to mark on the select keys K2, K3, . . . on the dictionary case, the CPU 21 marks, according to the case print data, on the surface or top of the select keys K2, K3, . . . of the actual electronic dictionary D corresponding to the select key names (for example, “AAAAA”, “DDDDD”, and “HHHHH”) assigned to the select keys 43a, 44a, 45a, 43b, 44b, 45b, . . . selected by the customer. Thus, the result is as shown in FIG. 22.

As can be seen from FIG. 22, “AAAAA”, “DDDDD”, “HHHHH” and so forth are marked on the select keys K2, K3, . . . of the electronic dictionary hardware D. When the left side key print data in FIG. 22 is overlaid on the actual electronic dictionary D, the result is as shown on the right.

The CPU 21 writes the write data and the like stored in the memory 22 into the electronic dictionary storage unit M in the actual electronic dictionary D (step S93).

When the write data stored in the memory 22 is data for designating the select key name of the select key “AAAAA”, the electronic dictionary data corresponding to the select key name of the select key “AAAAA” is written into the electronic dictionary memory unit M in the actual electronic dictionary D. When the write data stored in the memory 22 is data for designating the select key name of the select key “DDDDD”, the electronic dictionary data corresponding to the select key name of the select key “DDDDD” is written into the electronic dictionary memory unit M in the actual electronic dictionary D.

The CPU 21 outputs an instruction signal for packaging the produced dictionary, and attaching an invoice of the name and address of the ordering customer (step S94). The CPU 21 outputs an instruction signal to the management server etc. so as to ship to the person in charge or manager (step S95).

According to the communication device 1 and manufacture support server 2 of the first embodiment, when the transmission controller 25 specifies the select keys or icons in the keyboard in the electronic dictionary image displayed in the display unit 14 of the communication device 1, the dictionary name designation data transmitted from the communication device 1 is received, and the electronic dictionary data corresponding to the dictionary name designated by the received dictionary name designation data is read out from the memory 22 which stores plural sets of dictionary name and electronic dictionary data with being related to each other. The CPU 21 writes the read-out electronic dictionary data into the electronic dictionary storage unit M provided in the actual electronic dictionary D corresponding to the electronic dictionary image, and marks the dictionary name designated by the received dictionary name designation data on the surface of the key of the corresponding actual electronic dictionary D.

Therefore, even if the demanded function for the actual electronic dictionary D differs in each customer, when the-customer selects the select keys 43a, 44a, . . . in the electronic dictionary image displayed in the display unit 14, the electronic dictionary data corresponding to the selected key operation names can be written into the electronic dictionary storage unit M in the actual electronic dictionary D, and marking corresponding to the selected key operation names can be executed on the select keys K2, K3 to K11 provided in the actual electronic dictionary D. Hence, as intended by the customer, since the hardware of the actual electronic dictionary D can be customized, the hardware of the actual electronic dictionary D can be easily and automatically customized corresponding to the software of the electronic dictionary image.

When the customer inputs the own name, the actual electronic dictionary D can be marked with the own name by a marking processing unit N.

Since the price is calculated according to the electronic dictionary hardware selected by the customer and the dictionary name designation data, the customer can know the price while customizing the actual electronic dictionary D, so that a more user-friendly service can be provided.

Since the customer can customize while observing the electronic dictionary image same as the actual electronic dictionary D, it is easy to imagine the manufactured actual electronic dictionary D, and a user-friendly service can be provided.

### SECOND EMBODIMENT

A second embodiment of the invention will be explained. In the second embodiment, as compared with the first embodiment in which the select keys are written in Japanese, the characters of select keys can be selected from plural languages.

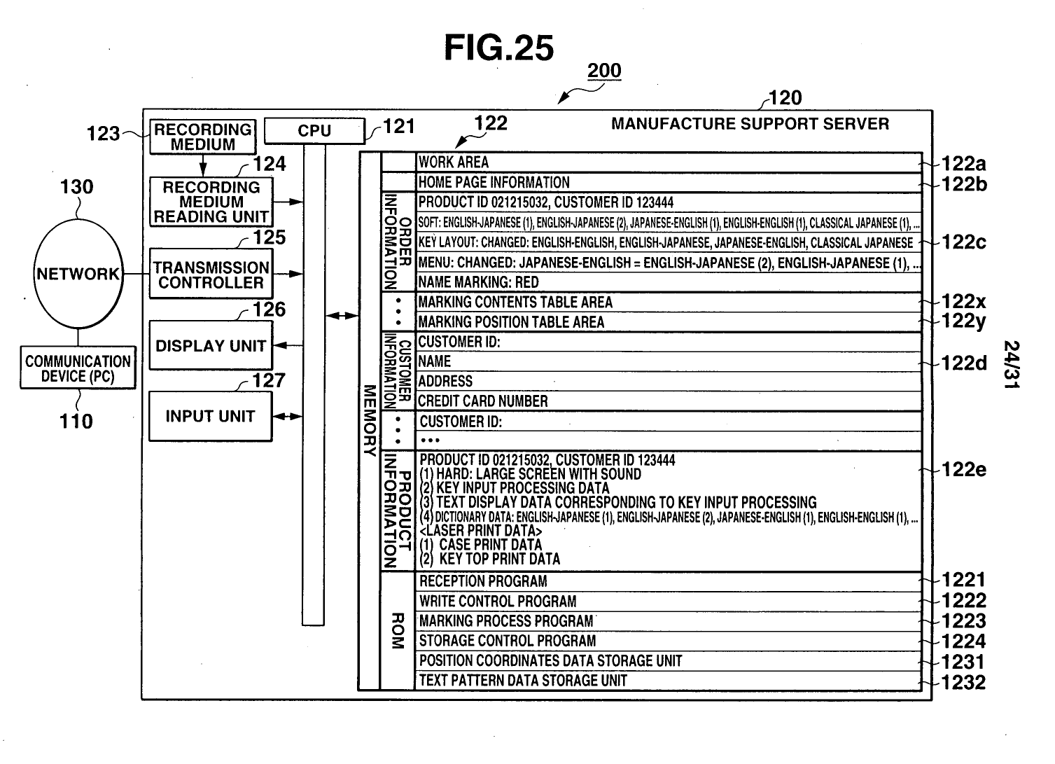

Process of customizing an electronic dictionary in this embodiment will be explained below by referring to FIGS. 25 to 32A and 32B.

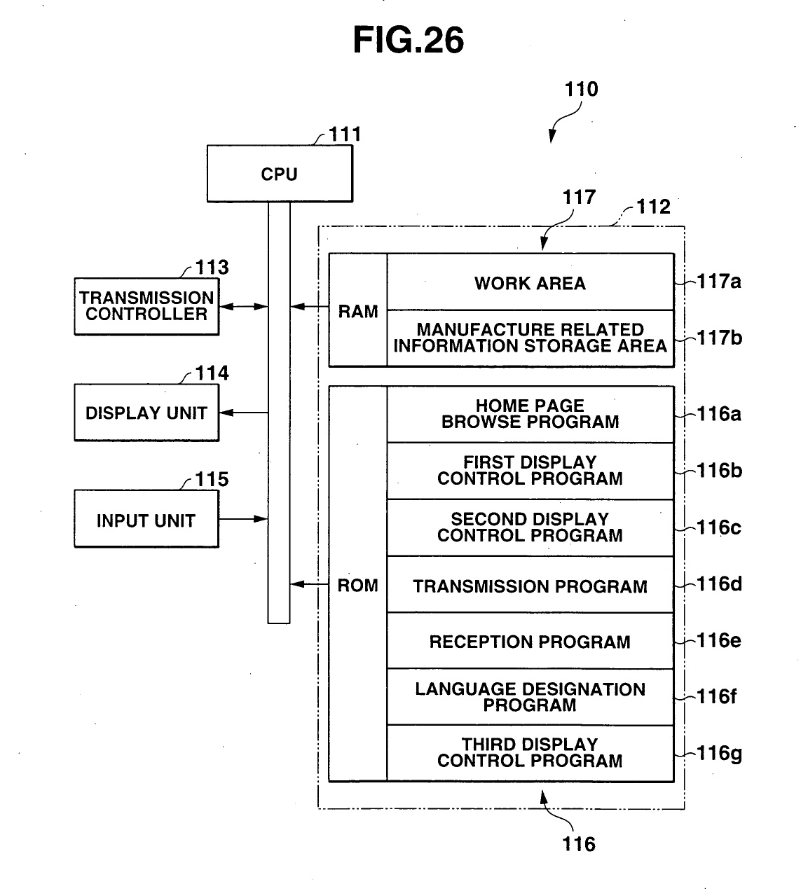

As shown in FIGS. 25 and 26, an electronic device manufacture support system 200 comprises a communication device 110 as a manufacture client terminal device possessed by a customer, and a manufacture support server 120 as an electronic device manufacture support apparatus possessed by a manufacturer of electronic dictionaries, which are connected together by means of a network 130. The second embodiment differs from the first embodiment in the block of dictionary selecting process, and only this block is explained in this embodiment.

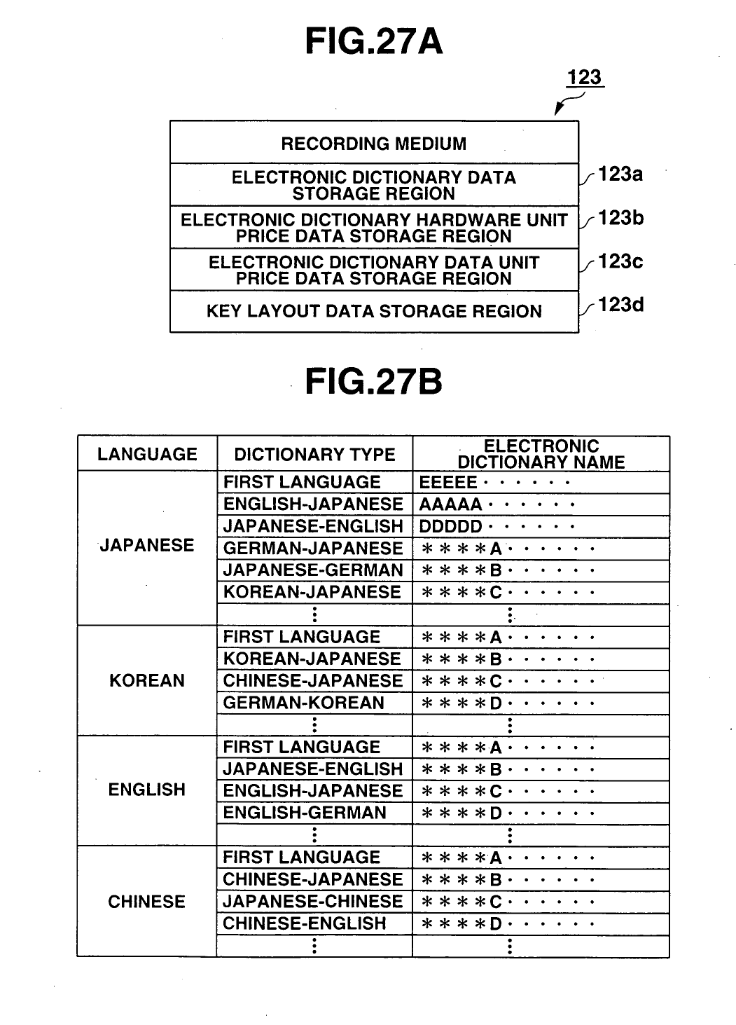

That is, as shown in FIG. 27A, electronic dictionary data corresponding to plural languages are stored in an electronic dictionary data storage region 123a of a recording medium 123 of the manufacture support server 120.

Specifically, as shown in FIG. 27B, for example, four types of selectable languages are set, and the electronic dictionary data to be written into the electronic dictionary differs depending on the language selected by the customer as the first language.

For example, when Japanese is selected as the first language, the types of dictionaries that can be written into the electronic dictionary are “first language”, “English-Japanese”, “Japanese-English”, “Japanese-German”, “German-Japanese”, “Korean-Japanese”, etc. The electronic dictionary data is stored corresponding to each type of dictionary. For example, “EEEEE” is for “first language”, and “AAAAA” for “English-Japanese”.

A CPU 121, according to the first language selected by the customer, reads the electronic dictionary data corresponding to the first language from the electronic dictionary data storage region 123a.

Key layout data corresponding to the first language is stored in a key layout data storage region 123d of the recording medium 123.

The CPU 121, according to the first language selected by the customer, reads the electronic dictionary data corresponding to the first language from the key layout data storage region 123d.

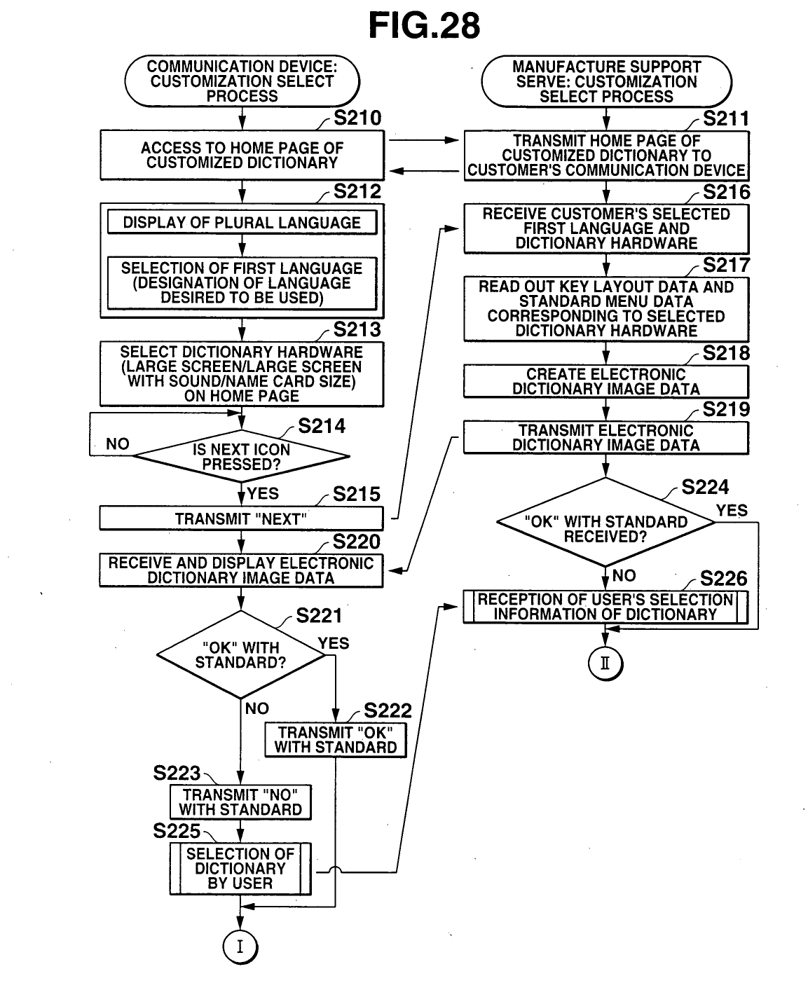

Selection of an electronic dictionary and key print operation in this electronic device manufacture support system will be explained by referring to FIGS. 28 to 30.

The customer accesses the home page of customized dictionaries (step S210). The CPU 121 causes the home page of “customized dictionary HP” including plural languages (four languages in this example) to be displayed in the display unit 114.

Thereafter, when the customer selects the first language for designating the language to be used on the home page (step S212), the information of the selected “first language” is transmitted to the manufacture support server 2 together with the dictionary hardware select information (step S215). When a transmission controller 125 of the manufacture support server 120 receives the first language select information, the CPU 121 of the manufacture support server 120 reads out the key layout data corresponding to the “first language” selected by the customer from the key layout storage region 123d of the recording medium 123, and writes into a marking contents table area 122x. Key print data is created so as to mark the text corresponding to the first language according to the key layout data (step S235).

As shown in FIGS. 28 and 29, of the electronic dictionary customizing process by the customer, the procedure other than steps S225 and S226 is same as in the first embodiment. Therefore, its explanation is omitted, and only steps S225 and S226 are described.

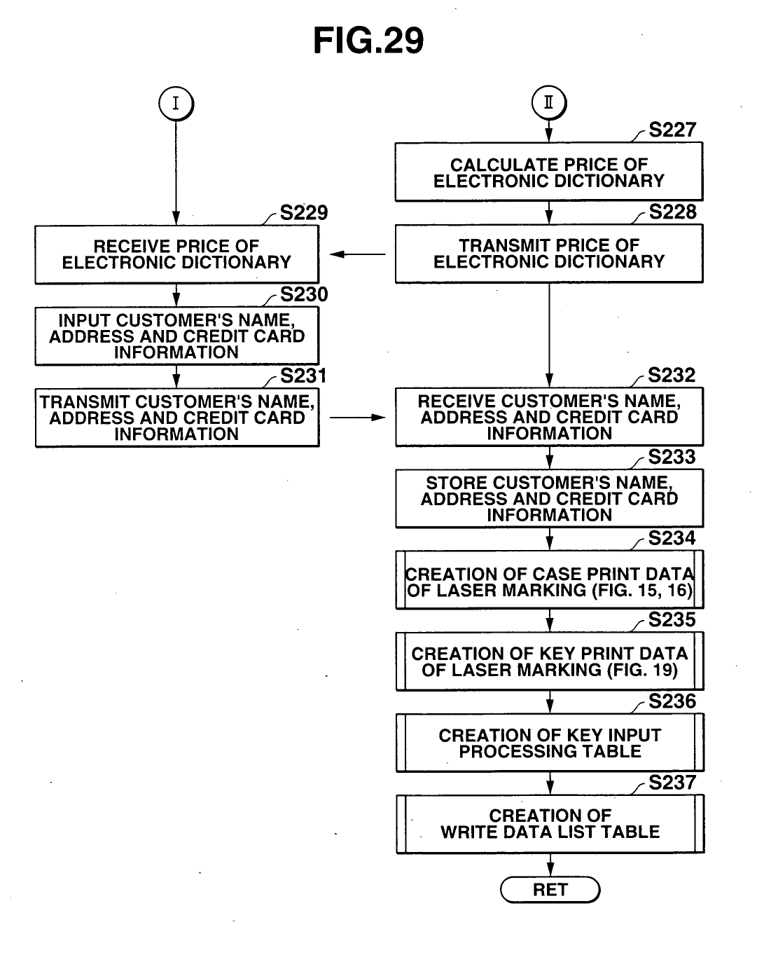

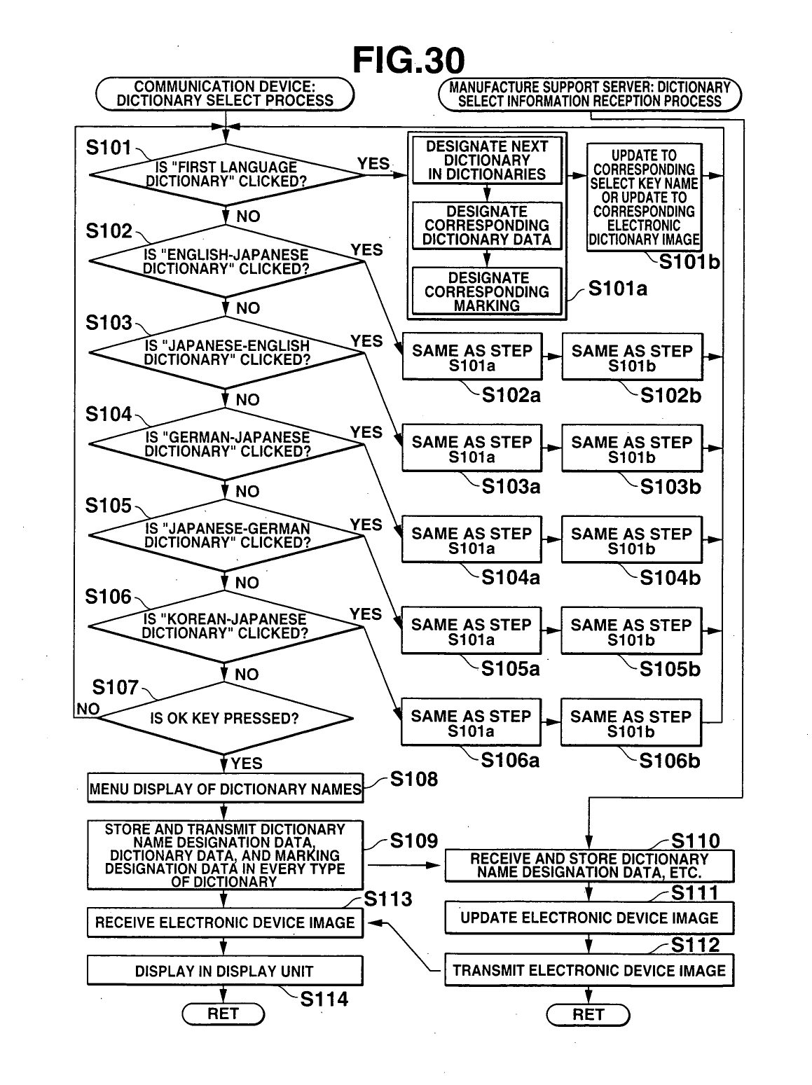

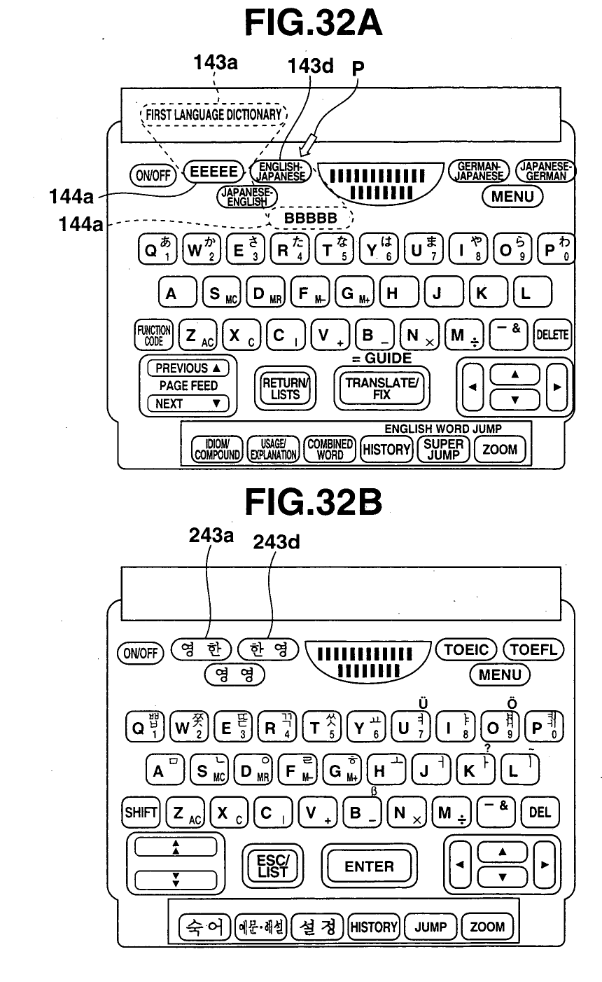

As shown in FIG. 32A, a CPU 111 of the communication device 110 determines whether or not the customer has manipulated a select key 143a (indicated by a broken line) of “first language dictionary” (step S101 of FIG. 30). When the CPU 111 determines that the customer has manipulated the select key of “first language dictionary” (Yes in step S101), a next electronic dictionary name (for example, “EEEEE”) among the dictionaries is designated, and the dictionary name designation data is stored in a manufacture related information area 117b in a RAM 117. The dictionary content corresponding to the next dictionary is designated, and the designated electronic dictionary data is stored in the manufacture related information area 117b in the same RAM 117. Marking process corresponding to the next dictionary is designated, and the marking designation data is stored also in the manufacture related information area 117b of the RAM 117 (step S101a).

The CPU 111 updates an image of a select key 144a showing the select key name (for example, select key name “EEEEE”) corresponding to the next electronic dictionary name selected in step S101. Or the CPU 111 updates to the electronic dictionary image (for example, electronic dictionary image “EEEEE”) in which the electronic dictionary name selected in step S101 is displayed in the select key (step S101b).

The CPU 111 determines whether or not the customer has manipulated the select key 144a having the updated select key name displayed therein (for example, select key name “EEEEE”) (step S101). When the CPU 111 determines that the customer has manipulated the select key 144a having “first language” or “EEEEE” displayed therein (Yes in step S101), further next electronic dictionary name (for example, “GGGGG”) among the dictionaries is designated, and the dictionary name designation data is stored in the manufacture related information area 117b in the RAM 117. The dictionary content corresponding to the next dictionary is designated, and the designated electronic dictionary data is stored in the manufacture related information area 117b in the same RAM 117. Marking process corresponding to the next dictionary is designated, and the marking designation data is stored also in the manufacture related information area 117b of the RAM 117 (step S101a).

The CPU 111 updates to the select key name (for example, select key name “GGGGG”) corresponding to the next electronic dictionary name selected in step S101. Or the CPU 11 updates to the electronic dictionary image (for example, electronic dictionary image “GGGGG”) in which the electronic dictionary name selected in step S101 is displayed in the select key (step S101b).

In this way, every time the select key of “first language dictionary” is selected, the dictionary name designation data corresponding to the next electronic dictionary name among the dictionaries of the “first language dictionary”, corresponding dictionary contents designation data, and corresponding marking designation data are stored in the manufacture related information area 117b of the RAM 117, while the electronic dictionary image in which the select key name corresponding to the selected next electronic dictionary name or the selected electronic dictionary name is displayed in the select key is updated (steps S101, S101a and S101b). As a result, any one of the electronic dictionaries “EEEEE”, “GGGGG”, etc. can be changed over and displayed.

On the other hand, instead of manipulating the select key 143a of “first language dictionary”, when the customer manipulates the select key 143a of “English-Japanese dictionary” (Yes in step S102), the CPU 11 designates a next electronic dictionary name (for example, “AAAAA”) among the dictionaries, and stores this dictionary name designation data in the manufacture related information area 117b in the RAM 117. The dictionary content corresponding to this next dictionary is designated, and the designated electronic dictionary data is stored in the manufacture related information area 117b in the same RAM 117. Marking process corresponding to the next dictionary is designated, and the marking designation data is also stored in the manufacture related information area 117b of the RAM 117 (step S102a).

The CPU 11 updates to the select key name (for example, select key name “AAAAA”) corresponding to the next electronic dictionary name selected in step S102. Or the CPU 11 updates to the electronic dictionary image (for example, electronic dictionary image “AAAAA”) in which the electronic dictionary name selected in step S102 is displayed in the select key (step S102b).

The CPU 11 determines whether or not the customer has manipulated the select key 143a having the updated select key name (for example, select key name “AAAAA”) displayed therein (step S102). When the CPU 11 determines that the customer has manipulated the select key 143a of “English-Japanese dictionary” (Yes in step S102), further next electronic dictionary name (for example, “BBBBB”) among the dictionaries is designated, and this dictionary name designation data is stored in the manufacture related information area 117b in the RAM 117. The dictionary content corresponding to this next dictionary is designated, and the designated electronic dictionary data is stored in the manufacture related information area 117b in the same RAM 117. Marking process corresponding to the next dictionary is designated, and the marking designation data is also stored in the manufacture related information area 117b of the RAM 117 (step S102a).

The CPU 11 updates to the select key name (for example, select key name “BBBBB”) corresponding to the next electronic dictionary name selected in step S102. Or the CPU 11 updates to the electronic dictionary image (for example, electronic dictionary image “BBBBB”) in which the electronic dictionary name selected in step S102 is displayed in the select key (step S102b).

In this manner, every time the select keys displaying the “English-Japanese dictionary” are manipulated, the dictionary name designation data corresponding to the next electronic dictionary name among dictionaries of “English-Japanese dictionary”, corresponding electronic dictionary data, and corresponding marking designation data are stored in the manufacture related information area 117b in the RAM 117, while the select key name corresponding to the selected next electronic dictionary name, or the selected electronic dictionary name displayed in the select key is updated (steps S102, S102a and S102b). As a result, any one of electronic dictionaries “AAAAA”, “BBBBB”, “CCCCC”, “DDDDD”, etc. can be changed over and displayed.

Hereinafter, the same procedure is repeated in the sequence of “Japanese-English dictionary”, “German-Japanese dictionary”, “Japanese-German dictionary”, and “Korean-Japanese dictionary” until the “OK key” is manipulated by the customer in step S107 (steps S103 to S106), and information of selected types of electronic dictionaries are stored in the manufacture related information area 117b.

When the CPU 11 determines that the customer has manipulated the “OK key” in step S107, the menu of available electronic dictionary data is shown in the display unit 114 (step S108).

The CPU 11 transmits the dictionary name designation data, electronic dictionary data, and marking designation data stored in the manufacture related information area 117b to the manufacture support server 120 (step S109). The manufacture support server 120 receives the transmitted dictionary name designation data, electronic dictionary data, and marking designation data in the transmission controller 125, and the CPU 121 stores in specified storage regions in an order information area 122c and a marking contents table area 122x in the memory 122 (step S110).

The CPU 121 of the manufacture support server 120 reads out the electronic dictionary name designated by the transmitted dictionary name designation data from the ROM, updates to the electronic dictionary image in which this read-out electronic dictionary name is displayed in the select key (step S111), and transmits the updated electronic dictionary; image to the communication device 110 (step S112). The communication device 110 receives the updated electronic dictionary image (step S113), and displays the image in the display unit 114 (step S114).

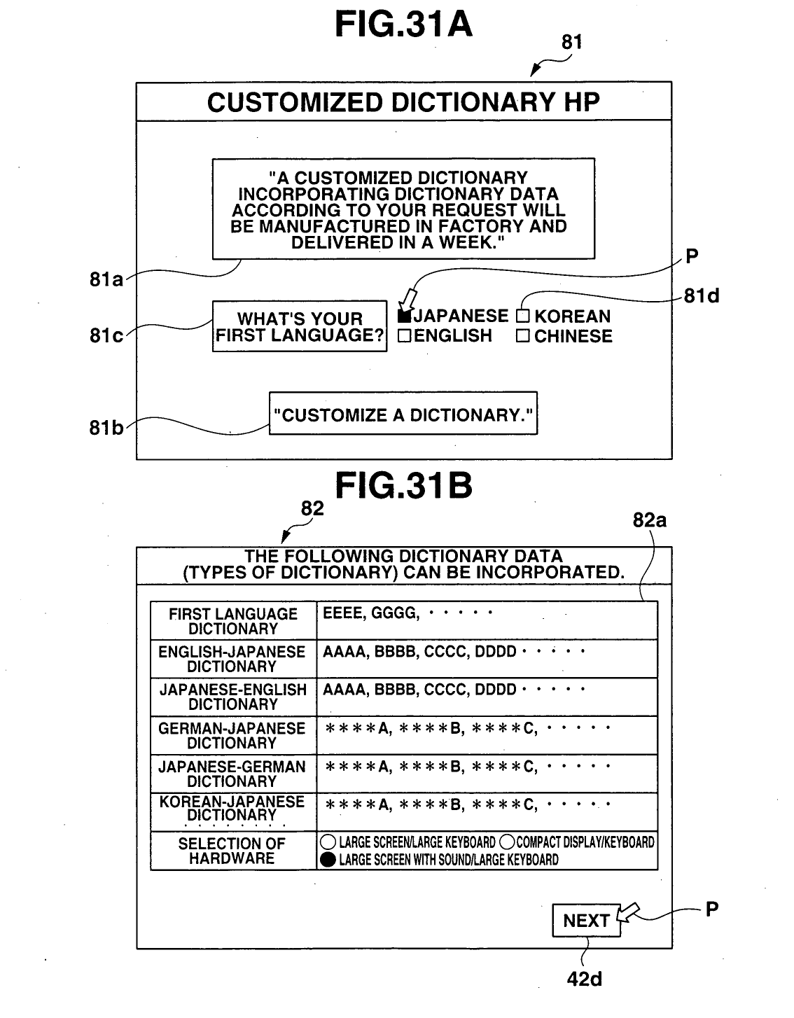

Explaining a specific example of display, when the communication device 110 receives the customized dictionary home page information from the manufacture support server 120, a first display screen 81 as shown in FIG. 31A appears on the screen. The first display screen 81 shows a guide message 81a such as “A customized dictionary incorporating dictionary data according to your request will be manufactured in factory and delivered in a week.” and a setting start icon 81b for determining the specification of a customized dictionary such as “Customize a dictionary.”

The first display screen 81 shows an electronic dictionary data list 81d of all types of dictionaries that can be mounted, aside from the types of dictionaries selected by the customer, such as first language dictionary, English-Japanese dictionary, Japanese-English dictionary, German-Japanese dictionary, Japanese-German dictionary, and Korean-Japanese dictionary.

When the customer clicks the setting start icon 81b by a mouse pointer P, the screen display is changed, and newly shows a second display screen 82 for selecting the electronic dictionary hardware as shown in FIG. 31B.

Among dictionaries, plural types of dictionary names are displayed, and dictionary names that can be mounted are open to the customer. For example, the first language dictionaries include “EEEEE”, “GGGGG”, etc. Dictionary names among first language dictionaries are changed according to the first language selected by the customer.

The electronic dictionary data list 82a shows, together with types of dictionaries, types of electronic dictionary hardware, such as “large screen/large keyboard,” “compact display/keyboard,” and “large screen with sound/large keyboard”. By clicking the select button 82b provided at the beginning of each type of hardware, the type of the electronic dictionary hardware is selected. In FIG. 31B, for example, as the type of the electronic dictionary hardware, “large screen with sound/large keyboard” is selected.

Since the key layout and standard menu are created on the basis of the Japanese language, the keys are usually laser marked with “A, KA, SA, TA, NA, etc.” as shown in FIG. 32A. However, when the customer selects Korean as the “first language”, for example, the CPU 121 of the manufacture support server 120 reads out the key layout data corresponding to Korean from the key layout storage region 123d of the recording medium 123, and creates key print data so as to mark Hangul characters as shown in FIG. 32B according to this layout data.

According to the communication device 110 and manufacture support server 120 of the second embodiment described herein, as shown in FIG. 31A, the customer is allowed to select the first language from plural languages on the home page, and the key print data and case print data of the electronic dictionary are created according to the selected first language. Therefore, even for manufacture clients of different mother tongues, electronic device images with icons showing plural dictionary names in the language suited to each manufacture client can be displayed. Consequently, the actual contents of the customized electronic dictionary can be checked easily, so that manufacturer of the customized electronic dictionary can be ordered with safety.

In the embodiments, the invention is applied in the apparatus or system for supporting manufacture of electronic dictionaries including electronic word book, electronic encyclopedia and the like, but the invention can be applied generally in all electronic devices including cellular phone, personal computer, electronic clock, electronic pocket diary, and the like.

According to one aspect of the invention, there is provided an electronic device manufacture support apparatus comprising:
means (transmission controller 25 in FIG. 2 and step S16 in FIG. 7) for receiving key operation names sequentially displayed on a surface of each of select keys in a keyboard of an electronic device image to be displayed on a network (network 3 in FIGS. 1 and 3) in response to a manipulation of any one of the select keys by means of a manufacture client terminal (communication device 1 in FIGS. 1 and 2);
write control means (CPU 21 in FIG. 4 and step S93 in FIG. 24) for writing predetermined contents data in response to the key operation name received by the receiving means to a contents storage unit (electronic dictionary storage unit M in FIG. 4) provided in an actual electronic device (electronic dictionary D in FIG. 4) corresponding to the electronic device image; and
marking processing means (CPU 21 in FIG. 2 and steps S91 and S92 in FIG. 24) for marking a key operation name on each of the select keys in the actual electronic device based on the key operation name received by the receiving means.

According to the aspect of the invention, the key operation names sequentially displayed on the surface of each of the select keys in the keyboard of the electronic device image to be displayed on the network are received in response to a manipulation of any one of the select keys by means of the manufacture client terminal. The write control means writes the predetermined contents data in response to the key operation name received by the receiving means to the contents storage unit provided in an actual electronic device corresponding to the electronic device image. The marking processing means marks the key operation name on each of the select keys in the actual electronic device based on the key operation name received by the receiving means.

Therefore, even if the customers require different specifications, a hardware of the electronic device is customized based on selected contents data by merely selecting a key name by a customer. Thus, both the software and hardware specifications can be customized easily and automatically.

According to another aspect of the invention, the electronic device manufacture support apparatus (manufacture support server 2 in FIGS. 1 and 3) further comprises:

position coordinates data storage means (position coordinates data storage unit 231 in FIG. 2) for storing position coordinates data of select keys of the actual electronic device corresponding to the select keys in the keyboard of the electronic device image; and

text pattern data storage means (text pattern data storage unit 232 in FIG. 2) for storing the key operation names and text pattern data of the key operation names with being related to each other, wherein the marking processing means comprises:
text pattern data reading means (CPU 21 in FIG. 2 and step S59 in FIG. 16) for reading out text pattern data corresponding to the key operation name received by the receiving means, from the text pattern data storage means;
position coordinates data reading means (CPU 21 in FIG. 2 and steps S62 and S63 in FIG. 16) for reading out the position coordinates data of a select key to be marked with the key operation name received by the receiving means, from the position coordinates data storage means; and
marking data creating means (CPU 21 in FIG. 2 and step S67 in FIG. 16) for creating marking data based on the text pattern data read out by the text pattern data reading means and the position coordinates data read out by the position coordinates data reading means.

According to the other aspect of the invention, the position coordinates data storage means stores position coordinates data of select keys of the actual electronic device corresponding to the select keys in the keyboard of the electronic device image. The marking processing means reads out text pattern data corresponding to the key operation name received by the receiving means, from the text pattern data storage means and reads out the position coordinates data of a select key to be marked with the key operation name received by the receiving means, from the position coordinates data storage means. The marking data creating means creates marking data based on the text pattern data read out by the text pattern data reading means and the position coordinates data read out by the position coordinates data reading means.

Therefore, even if the customers require different specifications, a hardware of the electronic device is customized based on selected contents data by merely selecting a key name by a customer. Thus, both the software and hardware specifications can be customized easily and automatically. Further, it is possible to correctly perform a marking of the hardware of the electronic device.

According to still another aspect of the invention, there is provided an electronic device manufacture support apparatus comprising:
means (recording medium 23 in FIG. 2) for storing plural sets of key operation names and contents data corresponding to the key operation names with being related to each other;
means (a transmission controller 25 in FIG. 2 and step S16 in FIG. 7) for receiving designation data for designating key operation names transmitted from a manufacture client terminal (communication device 1 in FIGS. 1 and 2), in response to a designation operation for plural key operations in a keyboard of an electronic device image to be displayed on a display unit (14) of the manufacture client terminal (1) or a network (3);
write control means (CPU 21 in FIG. 2 and step S93 in FIG. 24) for reading out contents data corresponding to the key operation name designated by the designation data received by the receiving means, from the storing means, and writing the read-out contents data into a contents storage unit (electronic dictionary storage unit M) provided in an actual electronic device (electronic dictionary D) corresponding to the electronic device image; and
marking processing means (CPU 21 in FIG. 2 and steps S94 and S92 in FIG. 24) for marking the key operation name designated by the designation data received by the receiving means on a corresponding select key of the actual electronic device.

According to the still another aspect of the invention, receiving means receives designation data for designating key operation names transmitted from a manufacture client terminal, in response to a designation operation for plural key operations in a keyboard of an electronic device image to be displayed on a display unit of the manufacture client terminal or a network. The write control means reads out contents data corresponding to the key operation name designated by the designation data received by the receiving means, from the storing means, and writes the read-out contents data into a contents storage unit provided in an actual electronic device corresponding to the electronic device image. The marking processing means marks the key operation name designated by the designation data received by the receiving means on a corresponding select key of the actual electronic device.

Therefore, even if the customers require different specifications, a hardware of the electronic device is customized based on selected contents data by merely selecting a key name by a customer. Thus, both the software and hardware specifications can be customized easily and automatically.

According to still another aspect of the invention, the electronic device manufacture support apparatus (2) according to claim 1, further comprising:
position coordinates data storage means (231) for storing position coordinates data of select keys of the actual electronic device corresponding to the select keys in the keyboard of the electronic device image; and
text pattern data storage means (232) for storing the key operation names and text pattern data of the key operation names with being related to each other, wherein the marking processing means comprises:
text pattern data reading means (CPU 21 in FIG. 2 and step S59 in FIG. 16) for reading out text pattern data corresponding to the key operation name designated by the designation data received by the receiving means, from the text pattern data storage means;
position coordinates data reading means (CPU 21 in FIG. 2 and steps S62 and S63 in FIG. 16) for reading out position coordinates data of a select key to be marked with the key operation name designated by the designation data received by the receiving means, from the position coordinates data storage means; and
marking data creating means (CPU 21 in FIG. 2 and step S67 in FIG. 16) for creating marking data based on the text pattern data read out by the text pattern data reading means and the position coordinates data read out by the position coordinates data reading means.

According to the still another aspect of the invention, the text pattern data reading means reads out text pattern data corresponding to the key operation name designated by the designation data received by the receiving means, from the text pattern data storage means. The position coordinates data reading means reads out position coordinates data of a select key to be marked with the key operation name designated by the designation data received by the receiving means, from the position coordinates data storage means. The marking data creating means creates marking data based on the text pattern data read out by the text pattern data reading means and the position coordinates data read out by the position coordinates data reading means.

Therefore, it is possible to correctly perform a marking of the hardware of the electronic device.

According to still another aspect of the invention, the electronic device manufacture support apparatus further comprises
key input processing table creating means (CPU 21 in FIG. 2 and step S36 in FIG. 8) for creating a key input processing table in which the select keys and the contents data corresponding to the key operation names marked on the select keys are corresponded with each other, and storing the table in the contents storage unit (electronic dictionary storage unit M).

According to the still another aspect of the invention, the key input processing table creating means creates a key input processing table in which the select keys and the contents data corresponding to the key operation names marked on the select keys are corresponded with each other, and stores the table in the contents storage unit.

Therefore, it is possible to easily and automatically correspond the customized hardware and software.

According to still another aspect of the invention, the electronic device manufacture support apparatus further comprises:
electronic device image creating means (CPU 21 in FIG. 2 and step S18 in FIG. 7) for creating an electronic device image corresponding to electronic device hardware select data selected and transmitted by the manufacture client terminal; and
transmitting means (transmission controller 25 in FIG. 2 and step S19 in FIG. 7) for transmitting the electronic device image created by the electronic device image creating means to the manufacture client terminal.

According to the still another aspect of the invention, the electronic device image creating means creates the electronic device image corresponding to electronic device hardware select data selected and transmitted by the manufacture client terminal. The transmitting means transmits the electronic device image created by the electronic device image creating means to the manufacture client terminal.

Since the customer can customize while observing the electronic dictionary image same as the actual electronic dictionary, it is easy to imagine the manufactured actual electronic dictionary, and a user-friendly service can be provided.

According to still another aspect of the invention, the electronic device manufacture support apparatus further comprises:
first storage means (electronic dictionary hardware unit price data storage region 23b in FIG. 5) for storing an electronic device hardware name and a price of the electronic device hardware name with being related to each other;
second storage means (electronic dictionary data unit price data storage region 23c in FIG. 5) for storing the key operation name and a price of contents data corresponding to the key operation name with being related to each other;
means (CPU 21 in FIG. 2 and step S28 in FIG. 8) for reading out the price of the electronic device hardware corresponding to the received electronic device hardware select data from the first storage means, and reading out the price of the contents data corresponding to the received key operation name from the second storage means;
means (CPU 21 in FIG. 2 and step S27 in FIG. 8) for calculating a price of the electronic device based on the prices read out by the reading means; and
means (transmission controller 25 in FIG. 2 and step S28 in FIG. 8) for transmitting the price calculated by the calculating means to the manufacture client terminal.

According to the still another aspect of the invention, the reading means reads out the price of the electronic device hardware corresponding to the received electronic device hardware select data from the first storage means, and reads out the price of the contents data corresponding to the received key operation name from the second storage means. The calculating means calculates a price of the electronic device based on the prices read out by the reading means. The transmitting means transmits the price calculated by the calculating means to the manufacture client terminal.

Since the price is calculated according to the electronic dictionary hardware selected by the customer and the dictionary name designation data, the customer can know the price while customizing the actual electronic dictionary, so that a more user-friendly service can be provided.

According to still another aspect of the invention, the electronic device manufacture support apparatus further comprises means (CPU 21 in FIG. 2 and step S5 in FIG. 6) for accounting the price calculated by the calculating means.

Since the accounting means accounts the price calculated by the calculating means, the user easily pay for the electronic device.

According to still another aspect of the invention, there is provided an electronic device manufacture support apparatus comprising:
means (recording medium 23 in FIG. 2) for storing plural sets of dictionary names and electronic dictionary data with being related to each other;
means (transmission controller 25 in FIG. 2 and step S16 in FIG. 7) for receiving dictionary name designation data transmitted from a manufacture client terminal, in response to designation operation for dictionary name select keys in a keyboard of an electronic dictionary image displayed on a display unit of the manufacture client terminal;
write control means (CPU 21 in FIG. 2 and step S93 in FIG. 24) for reading out electronic dictionary data corresponding to the dictionary name designated by the dictionary name designation data and received by the receiving means from the storage means, and writing the read-out electronic dictionary data into an electronic dictionary storage unit (electronic dictionary storage unit M in FIG. 4) provided in an actual electronic device (electronic dictionary D in FIG. 4) corresponding to the electronic dictionary image; and
marking processing means (CPU 21 in FIG. 2 and steps S91 and S92 in FIG. 24) for marking the dictionary name designated by the dictionary name designation data received by the receiving means on a corresponding select key of the actual electronic dictionary.

According to the still another aspect of the invention, the write control means reads out electronic dictionary data corresponding to the dictionary name designated by the dictionary name designation data and received by the receiving means from the storage means, and writes the read-out electronic dictionary data into an electronic dictionary storage unit provided in an actual electronic device corresponding to the electronic dictionary image. The marking processing means marks the dictionary name designated by the dictionary name designation data received by the receiving means on a corresponding select key of the actual electronic dictionary.

Therefore, even if the customers require different specifications, a hardware of the electronic device is customized based on selected contents data by merely selecting a key name by a customer. Thus, both the software and hardware specifications can be customized easily and automatically.

According to still another aspect of the invention, the electronic device manufacture support apparatus further comprises:
personal name data receiving means (transmission controller 25 in FIG. 2) for receiving personal name data transmitted from the manufacture client terminal; and
personal name marking processing means (CPU 21 in FIG. 2 and step S91 in FIG. 24) for marking the personal name data on the actual electronic device.

According to the still another aspect of the invention, the personal name data receiving means receives personal name data transmitted from the manufacture client terminal. The personal name marking processing means marks the personal name data on the actual electronic device.

Since the electronic device with the name of an owner being printed is manufactured, the identifier of the electronic device is very enhanced.

According to still another aspect of the invention, there is provided an electronic device manufacture support apparatus comprising:
first display control means (CPU 11 in FIG. 3 and step S20 in FIG. 7) for displaying an electronic device image having select keys on which plural key operation names are displayed;
second display control means (CPU 11 in FIG. 3, step S20 in FIG. 7, and steps S141-S146, S141a;S141b-S146a;S146b in FIG. 9) for changing over the key operation name displayed on a surface of a designated select key to another key operation name sequentially every time any one of the select keys displayed by the first display control means is manipulated, and displaying the newly changed key operation name;
means (CPU 13 in FIG. 3 and step S149 in FIG. 9) for transmitting the displayed key operation name changed over by the second display control means to an electronic device manufacture support apparatus (manufacture support server 2 in FIGS. 1 and 3); and
means (transmission controller 13 in FIG. 3 and step S159 in FIG. 9) for receiving manufacture related information about an electronic device image having a select key corresponding to the key operation name transmitted from the electronic device manufacture support apparatus or an actual electronic device (electronic dictionary D in FIG. 4) corresponding to the electronic device image, after the key operation name is transmitted by the transmitting means.

According to the still another aspect of the invention, the first display control means displays an electronic device image having select keys on which plural key operation names are displayed. The second display control means changes over the key operation name displayed on a surface of a designated select key to another key operation name sequentially every time any one of the select keys displayed by the first display control means is manipulated, and displays the newly changed key operation name. The transmitting means transmits the displayed key operation name changed over by the second display control means to an electronic device manufacture support apparatus. The receiving means receives manufacture related information about an electronic device image having a select key corresponding to the key operation name transmitted from the electronic device manufacture support apparatus or an actual electronic device corresponding to the electronic device image, after the key operation name is transmitted by the transmitting means.

Since a manufacture client can receive the manufacture related information about an electronic device image having a select key corresponding to the key operation name transmitted from the electronic device manufacture support apparatus or an actual electronic device corresponding to the electronic device image only by selecting the key operation name, it is possible to easily confirm the details of the customized electronic device. The manufacture client can easily order the customized electronic device without anxiety.

According to still another aspect of the invention, there is provided an electronic device manufacture support apparatus comprising:
first display control means (CPU 111 in FIG. 26, step S225 in FIG. 28 and FIG. 31A) for displaying plural languages;
means (input unit 115 in FIG. 26 and mouse pointer P in FIG. 31) for designating a language desired to be used from the plural languages displayed by the first display control means;
second display control means (CPU 121 in FIG. 26, step S225 in FIG. 28 and FIG. 32A) for displaying an electronic device image having select keys on which plural key operation names using the desired language designated by the designating means are displayed;
third display control means (CPU 111 in FIG. 26, steps S101-S106, S101a;S101b-S106a;S106b in FIG. 30) for changing over the key operation name displayed on a surface of a designated select key sequentially to another key operation name, every time any one of the select keys displayed by the second display control means is manipulated, and displaying the newly changed key operation name;
means (transmission controller 125 in FIG. 26 and step S109 in FIG. 30) for transmitting the key operation name changed over and displayed by the third display control means to an electronic device manufacture support apparatus; and
means (transmission controller 125 in FIG. 26 and step S113 in FIG. 30) for receiving manufacture related information about an actual electronic device (electronic dictionary D in FIG. 4) having a select key corresponding to the key operation name transmitted from the electronic device manufacture support apparatus, after the key operation name is transmitted from the transmitting means.

According to the still another aspect of the invention, the first display control means displays plural languages. The designating means designates a language desired to be used from the plural languages displayed by the first display control means. The second display control means displays an electronic device image having select keys on which plural key operation names using the desired language designated by the designating means are displayed. The third display control means changes over the key operation name displayed on a surface of a designated select key sequentially to another key operation name, every time any one of the select keys displayed by the second display control means is manipulated, and displays the newly changed key operation name. The transmission means transmits the key operation name changed over and displayed by the third display control means to an electronic device manufacture support apparatus. The receiving means receives manufacture related information about an actual electronic device having a select key corresponding to the key operation name transmitted from the electronic device manufacture support apparatus, after the key operation name is transmitted from the transmitting means.

Therefore, even for manufacture clients of different mother tongues, electronic device images with icons showing plural dictionary names in the language suited to each manufacture client can be displayed. Consequently, the actual contents of the customized electronic dictionary can be checked easily, so that manufacturer of the customized electronic dictionary can be ordered with safety.

According to still another aspect of the invention, there is provided an article of manufacture comprising a computer usable medium having computer readable program code means embodied therein, the computer readable program code means comprising:
computer readable program code means (reception program 221 in FIG. 2 and step S150 in FIG. 9) for causing a computer to receive key operation names sequentially displayed on a surface of each of select keys in a keyboard of an electronic device image to be displayed on a network (network 3 in FIGS. 1 and 3) in response to a manipulation of any one of the select keys by means of a manufacture client terminal (communication device 1 in FIGS. 1 and 3);
computer readable program code means (write control program 222 in FIG. 2 and step S93 in FIG. 24) for causing a computer to write predetermined contents data in response to the received key operation name to a contents storage unit (electronic dictionary storage unit M in FIG. 4) provided in an actual electronic device (electronic dictionary D in FIG. 4) corresponding to the electronic device image; and
computer readable program code means (marking process program 223 in FIG. 2 and steps S91 and S92 in FIG. 24) for causing a computer to mark a key operation name on each of the select keys in the actual electronic device based on the received key operation name.

According to the still another aspect of the invention, the computer readable program code means causes a computer to receive key operation names sequentially displayed on a surface of each of select keys in a keyboard of an electronic device image to be displayed on a network in response to a manipulation of any one of the select keys by means of a manufacture client terminal; causes a computer to write predetermined contents data in response to the received key operation name to a contents storage unit provided in an actual electronic device corresponding to the electronic device image; and causes a computer to mark a key operation name on each of the select keys in the actual electronic device based on the received key operation name.

Therefore, even if the customers require different specifications, a hardware of the electronic device is customized based on selected contents data by merely selecting a key name by a customer. Thus, both the software and hardware specifications can be customized easily and automatically.

According to still another aspect of the invention, there is provided an article of manufacture comprising a computer usable medium having computer readable program code means embodied therein, the computer readable program code means comprising:
computer readable program code means (reception program 221 in FIG. 2 and step S150 in FIG. 8) for causing a computer to receive device data relating to an electronic device requested to manufacture from a manufacture client terminal (communication device 1 in FIGS. 1 and 3) by way of communication means (3);
computer readable program code means (write control program 222 in FIG. 2 and step S93 in FIG. 24) for causing a computer to write predetermined contents data in response to the received device data to a contents storage unit (M) provided in the requested electronic device (D); and
computer readable program code means (marking process program 223 in FIG. 2 and steps S91 and S92 in FIG. 24) for causing a computer to mark a key operation name included in the received device data.

According to the still another aspect of the invention, the computer readable program code means causes a computer to receive device data relating to an electronic device requested to manufacture from a manufacture client terminal by way of communication means; causes a computer to write predetermined contents data in response to the received device data to a contents storage unit provided in the requested electronic device; and causes a computer to mark a key operation name included in the received device data.

Therefore, even if the customers require different specifications, a hardware of the electronic device is customized based on selected contents data by merely selecting a key name by a customer. Thus, both the software and hardware specifications can be customized easily and automatically.

According to still another aspect of the invention, there is provided an article of manufacture comprising a computer usable medium having computer readable program code means embodied therein, the computer readable program code means comprising:
computer readable program code means (write control program 223 in FIG. 2 and step S150 in FIG. 8) for causing a computer to store plural sets of key operation names and contents data corresponding to the key operation names with being related to each other;
computer readable program code means (reception program 221 in FIG. 2 and step S150 in FIG. 8) for causing a computer to receive designation data for designating key operation names transmitted from a manufacture client terminal (communication device 1 in FIGS. 1 and 3), in response to a designation operation for plural key operations in a keyboard of an electronic device image to be displayed on a display unit (display unit 14 in FIGS. 1 and 3) of the manufacture client terminal (communication device 1 in FIGS. 1 and 3) or a network (network 3 in FIGS. 1 and 3);
computer readable program code means (write control program 222 in FIG. 2 and step S93 in FIG. 24) for causing a computer to read out contents data corresponding to the received and designated key operation name, from storing means, and write the read-out contents data into a contents storage unit (electronic dictionary storage unit M in FIG. 4) provided in an actual electronic device (electronic dictionary D in FIG. 4) corresponding to the electronic device image; and
computer readable program code means (Marking process program 223 in FIG. 2 and steps S91 and S92 in FIG. 24) for causing a computer to mark the received and designated key operation name on a corresponding select key of the actual electronic device.

According to the still another aspect of the invention, the computer readable program code means causes a computer to store plural sets of key operation names and contents data corresponding to the key operation names with being related to each other; causes a computer to receive designation data for designating key operation names transmitted from a manufacture client terminal, in response to a designation operation for plural key operations in a keyboard of an electronic device image to be displayed on a display unit of the manufacture client terminal or a network; causes a computer to read out contents data corresponding to the received and designated key operation name, from storing means, and write the read-out contents data into a contents storage unit provided in an actual electronic device corresponding to the electronic device image; and causes a computer to mark the received and designated key operation name on a corresponding select key of the actual electronic device.

Therefore, even if the customers require different specifications, a hardware of the electronic device is customized based on selected contents data by merely selecting a key name by a customer. Thus, both the software and hardware specifications can be customized easily and automatically.

According to still another aspect of the invention, there is provided an article of manufacture comprising a computer usable medium having computer readable program code means embodied therein, the computer readable program code means comprising:
computer readable program code means (storage control program 224 in FIG. 2 and step S150 in FIG. 8) for causing a computer to store plural sets of dictionary names and electronic dictionary data with being related to each other;
computer readable program code means (reception program 221 in FIG. 2 and step S150 in FIG. 8) for causing a computer to receive dictionary name designation data transmitted from a manufacture client terminal, in response to designation operation for dictionary name select keys in a keyboard of an electronic dictionary image displayed on a display unit of the manufacture client terminal;
computer readable program code means (write control program 222 in FIG. 2 and step S93 in FIG. 24) for causing a computer to read out electronic dictionary data corresponding to the received and designated dictionary name from storage means, and write the read-out electronic dictionary data into an electronic dictionary storage unit (M) provided in an actual electronic device (D) corresponding to the electronic dictionary image; and
computer readable program code means (marking process program 223 in FIG. 2 and steps S91 and S92 in FIG. 24) for causing a computer to mark the received and designated dictionary name on a corresponding select key of the actual electronic dictionary.

According to the still another aspect of the invention, computer readable program code means causes a computer to store plural sets of dictionary names and electronic dictionary data with being related to each other; causes a computer to receive dictionary name designation data transmitted from a manufacture client terminal, in response to designation operation for dictionary name select keys in a keyboard of an electronic dictionary image displayed on a display unit of the manufacture client terminal; causes a computer to read out electronic dictionary data corresponding to the received and designated dictionary name from storage means, and write the read-out electronic dictionary data into an electronic dictionary storage unit (M) provided in an actual electronic device (D) corresponding to the electronic dictionary image; and causes a computer to mark the received and designated dictionary name on a corresponding select key of the actual electronic dictionary.

Therefore, even if the customers require different specifications, a hardware of the electronic device is customized based on selected contents data by merely selecting a key name by a customer. Thus, both the software and hardware specifications can be customized easily and automatically.

According to still another aspect of the invention, there is provided an article of manufacture comprising a computer usable medium having computer readable program code means embodied therein, the computer readable program code means comprising:
computer readable program code means (first display control program 16b in FIG. 3 and step S20 in FIG. 17) for causing a computer to operate as first display control means (11) for displaying an electronic device image having select keys on which plural key operation names are displayed;
computer readable program code means (second display control program 16c in FIG. 3 and step S20 in FIG. 7) for causing a computer to operate as second display control means (11) for changing over the key operation name displayed on a surface of a designated select key to another key operation name sequentially every time any one of the select keys displayed by the first display control means is manipulated, and displaying the newly changed key operation name;
computer readable program code means (transmission program 16d in FIG. 3 and step S149 in FIG. 9) for causing a computer to operate as means (13) for transmitting the displayed key operation name changed over by the second display control means to an electronic device manufacture support apparatus (2); and
computer readable program code means (reception program 16e in FIG. 3 and step S153 in FIG. 9) for causing a computer to operate as means (13) for receiving manufacture related information about an electronic device image having a select key corresponding to the key operation name transmitted from the electronic device manufacture support apparatus or an actual electronic device (D) corresponding to the electronic device image, after the key operation name is transmitted by the transmitting means.

According to still another aspect of the invention, there is provided an article of manufacture comprising a computer usable medium having computer readable program code means embodied therein, the computer readable program code means comprising:
computer readable program code means (first display control program 16b in FIG. 3 and step S20 in FIG. 17) for causing a computer to operate as first display control means (11) for displaying an electronic device image having select keys on which plural key operation names are displayed;
computer readable program code means (second display control program 16c in FIG. 3 and step S20 in FIG. 7) for causing a computer to operate as second display control means (11) for changing over the key operation name displayed on a surface of a designated select key to another key operation name sequentially every time any one of the select keys displayed by the first display control means is manipulated, and displaying the newly changed key operation name;
computer readable program code means (transmission program 16d in FIG. 3 and step S149 in FIG. 9) for causing a computer to operate as means (13) for transmitting the displayed key operation name changed over by the second display control means to an electronic device manufacture support apparatus (2); and
computer readable program code means (reception program 16e in FIG. 3 and step S153 in FIG. 9) for causing a computer to operate as means (13) for receiving manufacture related information about an electronic device image having a select key corresponding to the key operation name transmitted from the electronic device manufacture support apparatus or an actual electronic device (D) corresponding to the electronic device image, after the key operation name is transmitted by the transmitting means.

According to the still another aspect of the invention, the computer readable program code means causes a computer to operate as first display control means (11) for displaying an electronic device image having select keys on which plural key operation names are displayed; causes a computer to operate as second display control means (11) for changing over the key operation name displayed on a surface of a designated select key to another key operation name sequentially every time any one of the select keys displayed by the first display control means is manipulated, and displaying the newly changed key operation name; causes a computer to operate as means (13) for transmitting the displayed key operation name changed over by the second display control means to an electronic device manufacture support apparatus (2); and causes a computer to operate as means (13) for receiving manufacture related information about an electronic device image having a select key corresponding to the key operation name transmitted from the electronic device manufacture support apparatus or an actual electronic device (D) corresponding to the electronic device image, after the key operation name is transmitted by the transmitting means.

Therefore, even if the customers require different specifications, a hardware of the electronic device is customized based on selected contents data by merely selecting a key name by a customer. Thus, both the software and hardware specifications can be customized easily and automatically.

According to still another aspect of the invention, there is provided an article of manufacture comprising a computer usable medium having computer readable program code means embodied therein, the computer readable program code means comprising:
computer readable program code means (first display control program 116b in FIG. 26 and step S220 in FIG. 28) for causing a computer to operate as first display control means (111) for displaying plural languages;
computer readable program code means (language designation program 116f in FIG. 26 and steps S101-S106, S101a;S101b-S106a;S106b in FIG. 30) for causing a computer to operate as means (115, P) for designating a language desired to be used from the plural languages displayed by the first display control means;
computer readable program code means (second display control program 116c in FIG. 26 and step S220 in FIG. 28) for causing a computer to operate as second display control means (121) for displaying an electronic device image having select keys on which plural key operation names using the desired language designated by the designating means are displayed;
computer readable program code means (third display control program 116g in FIG. 26 and step S220 in FIG. 28) for causing a computer to operate as third display control means (111) for changing over the key operation name displayed on a surface of a designated select key sequentially to another key operation name, every time any one of the select keys displayed by the second display control means is manipulated, and displaying the newly changed key operation name;
computer readable program code means (transmission program 116d in FIG. 26 and step S109 in FIG. 30) for causing a computer to operate as means (125) for transmitting the key operation name changed over and displayed by the third display control means to an electronic device manufacture support apparatus; and
computer readable program code means (reception program 116e in FIG. 26 and step S113 in FIG. 30) for causing a computer to operate as means (125) for receiving manufacture related information about an actual electronic device (D) having a select key corresponding to the key operation name transmitted from the electronic device manufacture support apparatus, after the key operation name is transmitted from the transmitting means.

According to the still another aspect of the invention, the computer readable program code means causes a computer to operate as first display control means (111) for displaying plural languages; causes a computer to operate as means (115, P) for designating a language desired to be used from the plural languages displayed by the first display control means; causes a computer to operate as second display control means (121) for displaying an electronic device image having select keys on which plural key operation names using the desired language designated by the designating means are displayed; causes a computer to operate as third display control means (111) for changing over the key operation name displayed on a surface of a designated select key sequentially to another key operation name, every time any one of the select keys displayed by the second display control means is manipulated, and displaying the newly changed key operation name; causes a computer to operate as means (125) for transmitting the key operation name changed over and displayed by the third display control means to an electronic device manufacture support apparatus; and causes a computer to operate as means (125) for receiving manufacture related information about an actual electronic device (D) having a select key corresponding to the key operation name transmitted from the electronic device manufacture support apparatus, after the key operation name is transmitted from the transmitting means.

Therefore, even if the customers require different specifications, a hardware of the electronic device is customized based on selected contents data by merely selecting a key name by a customer. Thus, both the software and hardware specifications can be customized easily and automatically.

The invention is not limited to the illustrated embodiments alone. For example, the dictionary name data to be mounted are arbitrary, and may be freely set by the manufacturer. The home page design, data processing procedure, and the like may be changed and modified freely as far as not departing from the true spirit and scope of the invention.

1. An electronic device manufacture support apparatus comprising:
a receiver which receives key operation names sequentially displayed on a surface of each of select keys in a keyboard of an electronic device image to be displayed on a network in response to a manipulation of any one of the select keys by means of a manufacture client terminal;
a write controller which writes predetermined contents data in response to the key operation name received by the receiver to a contents storage unit provided in an actual electronic device corresponding to the electronic device image; and
a marking processor which marks a key operation name on each of the select keys in the actual electronic device based on the key operation name received by the receiver.

2. An electronic device manufacture support apparatus comprising:
a receiver which receives device data relating to an electronic device requested to manufacture from a manufacture client terminal by way of a communication device;
a write controller which writes predetermined contents data in response to the device data received by the receiver to a contents storage unit provided in the requested electronic device; and
a marking processor which marks a key operation name included in the device data received by the receiver.

3. The electronic device manufacture support apparatus according to claim 1, further comprising:
a position coordinates data storage which stores position coordinates data of select keys of the actual electronic device corresponding to the select keys in the keyboard of the electronic device image; and
a text pattern data storage which stores the key operation names and text pattern data of the key operation names with being related to each other,
wherein the marking processor comprises:
a text pattern data reader which reads out text pattern data corresponding to the key operation name received by the receiver, from the text pattern data storage;
a position coordinates data reader which reads out the position coordinates data of a select key to be marked with the key operation name received by the receiver, from the position coordinates data storage; and
a marking data creating unit which creates marking data based on the text pattern data read out by the text pattern data reader and the position coordinates data read out by the position coordinates data reader.

4. An electronic device manufacture support apparatus comprising:
a memory which stores plural sets of key operation names and contents data corresponding to the key operation names with being related to each other;
a receiver which receives designation data for designating key operation names transmitted from a manufacture client terminal, in response to a designation operation for plural key operations in a keyboard of an electronic device image to be displayed on a display unit of the manufacture client terminal or a network;
a write controller which reads out contents data corresponding to the key operation name designated by the designation data received by the receiver, from the storage, and writes the read-out contents data into a contents storage provided in an actual electronic device corresponding to the electronic device image; and
a marking processor which marks the key operation name designated by the designation data received by the receiver on a corresponding select key of the actual electronic device.

5. The electronic device manufacture support apparatus according to claim 3, wherein the marking processor comprises:
a text pattern data reader which reads out text pattern data corresponding to the key operation name designated by the designation data received by the receiver, from the text pattern data storage;
a position coordinates data reader which reads out position coordinates data of a select key to be marked with the key operation name designated by the designation data received by the receiver, from the position coordinates data storage; and
a marking data creating unit which creates marking data based on the text pattern data read out by the text pattern data reader and the position coordinates data read out by the position coordinates data reader.

6. The electronic device manufacture support apparatus according to claim 1, further comprising:
a key input processing table creating unit which creates a key input processing table in which the select keys and the contents data corresponding to the key operation names marked on the select keys are corresponded with each other, and stores the table in the contents storage unit.

7. The electronic device manufacture support apparatus according to claim 1, further comprising:
an electronic device image creating unit which creates an electronic device image corresponding to electronic device hardware select data selected and transmitted by the manufacture client terminal; and
a transmitter which transmits the electronic device image created by the electronic device image creating unit to the manufacture client terminal.

8. The electronic device manufacture support apparatus according to claim 6, further comprising:
a first storage which stores an electronic device hardware name and a price of the electronic device hardware name with being related to each other;
a second storage which stores the key operation name and a price of contents data corresponding to the key operation name with being related to each other;
a reader which reads out the price of the electronic device hardware corresponding to the received electronic device hardware select data from the first storage, and reads out the price of the contents data corresponding to the received key operation name from the second storage;
a calculator which calculates a price of the electronic device based on the prices read out by the reader; and
a transmitter which transmits the price calculated by the calculator to the manufacture client terminal.

9. The electronic device manufacture support apparatus according to claim 7, further comprising:
an accounting unit which accounts the price calculated by the calculator.

10. An electronic device manufacture support apparatus comprising:
a memory which stores plural sets of dictionary names and electronic dictionary data with being related to each other;
a receiver which receives dictionary name designation data transmitted from a manufacture client terminal, in response to designation operation for dictionary name select keys in a keyboard of an electronic dictionary image displayed on a display unit of the manufacture client terminal;
a write controller which reads out electronic dictionary data corresponding to the dictionary name designated by the dictionary name designation data and received by the receiver from the memory, and writes the read-out electronic dictionary data into an electronic dictionary storage unit provided in an actual electronic device corresponding to the electronic dictionary image; and
a marking processor which marks the dictionary name designated by the dictionary name designation data received by the receiver on a corresponding select key of the actual electronic dictionary.

11. The electronic device manufacture support apparatus according to claim 1, further comprising:
a personal name data receiver which receives personal name data transmitted from the manufacture client terminal; and
a personal name marking processor which marks the personal name data on the actual electronic device.

12. An electronic device manufacture support apparatus comprising:
a first display controller which displays an electronic device image having select keys on which plural key operation names are displayed;
a second display controller which changes over the key operation name displayed on a surface of a designated select key to another key operation name sequentially every time any one of the select keys displayed by the first display controller is manipulated, and displaying the newly changed key operation name;
a transmitter which transmits the displayed key operation name changed over by the second display controller to an electronic device manufacture support apparatus; and
a receiver which receives manufacture related information about an electronic device image having a select key corresponding to the key operation name transmitted from the electronic device manufacture support apparatus or an actual electronic device corresponding to the electronic device image, after the key operation name is transmitted by the transmitter.

13. An electronic device manufacture support apparatus comprising:
a first display controller which displays plural languages;
a designating unit which designates a language desired to be used from the plural languages displayed by the first display controller;
a second display controller which displays an electronic device image having select keys on which plural key operation names using the desired language designated by the designating unit are displayed;
a third display controller which changes over the key operation name displayed on a surface of a designated select key sequentially to another key operation name, every time any one of the select keys displayed by the second display controller is manipulated, and displays the newly changed key operation name;
a transmitter which transmits the key operation name changed over and displayed by the third display controller to an electronic device manufacture support apparatus; and
a receiver which receives manufacture related information about an actual electronic device having a select key corresponding to the key operation name transmitted from the electronic device manufacture support apparatus, after the key operation name is transmitted from the transmitter.

14. An article of manufacture comprising a computer usable medium having computer readable program code means embodied therein, the computer readable program code means comprising:
computer readable program code means for causing a computer to receive key operation names sequentially displayed on a surface of each of select keys in a keyboard of an electronic device image to be displayed on a network in response to a manipulation of any one of the select keys by means of a manufacture client terminal;
computer readable program code means for causing a computer to write predetermined contents data in response to the received key operation name to a contents storage unit provided in an actual electronic device corresponding to the electronic device image; and
computer readable program code means for causing a computer to mark a key operation name on each of the select keys in the actual electronic device based on the received key operation name.

15. An article of manufacture comprising a computer usable medium having computer readable program code means embodied therein, the computer readable program code means comprising:
computer readable program code means for causing a computer to receive device data relating to an electronic device requested to manufacture from a manufacture client terminal by way of communication means;
computer readable program code means for causing a computer to write predetermined contents data in response to the received device data to a contents storage unit provided in the requested electronic device; and
computer readable program code means for causing a computer to mark a key operation name included in the received device data.

16. An article of manufacture comprising a computer usable medium having computer readable program code means embodied therein, the computer readable program code means comprising:
computer readable program code means for causing a computer to store plural sets of key operation names and contents data corresponding to the key operation names with being related to each other;
computer readable program code means for causing a computer to receive designation data for designating key operation names transmitted from a manufacture client terminal, in response to a designation operation for plural key operations in a keyboard of an electronic device image to be displayed on a display unit of the manufacture client terminal or a network;
computer readable program code means for causing a computer to read out contents data corresponding to the received and designated key operation name, from storing means, and write the read-out contents data into a contents storage unit provided in an actual electronic device corresponding to the electronic device image; and
computer readable program code means for causing a computer to mark the received and designated key operation name on a corresponding select key of the actual electronic device.

17. An article of manufacture comprising a computer usable medium having computer readable program code means embodied therein, the computer readable program code means comprising:
computer readable program code means for causing a computer to store plural sets of dictionary names and electronic dictionary data with being related to each other;
computer readable program code means for causing a computer to receive dictionary name designation data transmitted from a manufacture client terminal, in response to designation operation for dictionary name select keys in a keyboard of an electronic dictionary image displayed on a display unit of the manufacture client terminal;
computer readable program code means for causing a computer to read out electronic dictionary data corresponding to the received and designated dictionary name from storage means, and write the read-out electronic dictionary data into an electronic dictionary storage unit provided in an actual electronic device corresponding to the electronic dictionary image; and
computer readable program code means for causing a computer to mark the received and designated dictionary name on a corresponding select key of the actual electronic dictionary.

18. An article of manufacture comprising a computer usable medium having computer readable program code means embodied therein, the computer readable program code means comprising:
computer readable program code means for causing a computer to operate as first display control means for displaying an electronic device image having select keys on which plural key operation names are displayed;
computer readable program code means for causing a computer to operate as second display control means for changing over the key operation name displayed on a surface of a designated select key to another key operation name sequentially every time any one of the select keys displayed by the first display control means is manipulated, and displaying the newly changed key operation name;
computer readable program code means for causing a computer to operate as means for transmitting the displayed key operation name changed over by the second display control means to an electronic device manufacture support apparatus; and
computer readable program code means for causing a computer to operate as means for receiving manufacture related information about an electronic device image having a select key corresponding to the key operation name transmitted from the electronic device manufacture support apparatus or an actual electronic device corresponding to the electronic device image, after the key operation name is transmitted by the transmitting means.

19. An article of manufacture comprising a computer usable medium having computer readable program code means embodied therein, the computer readable program code means comprising:
computer readable program code means for causing a computer to operate as first display control means for displaying plural languages;
computer readable program code means for causing a computer to operate as means for designating a language desired to be used from the plural languages displayed by the first display control means;
computer readable program code means for causing a computer to operate as second display control means for displaying an electronic device image having select keys on which plural key operation names using the desired language designated by the designating means are displayed;
computer readable program code means for causing a computer to operate as third display control means for changing over the key operation name displayed on a surface of a designated select key sequentially to another key operation name, every time any one of the select keys displayed by the second display control means is manipulated, and displaying the newly changed key operation name;
computer readable program code means for causing a computer to operate as means for transmitting the key operation name changed over and displayed by the third display control means to an electronic device manufacture support apparatus; and
computer readable program code means for causing a computer to operate as means for receiving manufacture related information about an actual electronic device having a select key corresponding to the key operation name transmitted from the electronic device manufacture support apparatus, after the key operation name is transmitted from the transmitting means.
